(19) United States
(12) Patent Application Publication
(10) Pub. No.: US 2026/0121811 A1
(43) Pub. Date: Apr. 30, 2026

(54) METHOD AND SYSTEM FOR ULTRA-HIGH-RELIABILITY NULL DATA PACKET ANNOUNCEMENT SIGNALLING

(71) Applicant: HUAWEI TECHNOLOGIES CO., LTD., SHENZHEN (CN)

(72) Inventors: Mahmoud HASABELNABY, Kanata (CA); Jung Hoon SUH, Kanata (CA); Osama ABOUL-MAGD, Kanata (CA); Yan XIN, Kanata (CA); Sara NOROUZI, Kanata (CA)

(73) Assignee: HUAWEI TECHNOLOGIES CO., LTD., SHENZHEN (CN)

(21) Appl. No.: 18/979,171

(22) Filed: Dec. 12, 2024

Related U.S. Application Data
(60) Provisional application No. 63/712,208, filed on Oct. 25, 2024.
(60) Provisional application No. 63/712,763, filed on Oct. 28, 2024.

(51) Int. Cl. H04L 5/00; H04L 1/00

(52) U.S. Cl. CPC H04L 5/0053; H04L 1/0068; H04L 5/0044

(57) ABSTRACT

Systems and methods for indicating a Wi-Fi™ standard in a null data physical layer protocol data unit (PPDU) announcement (NDPA) frame that includes a sounding dialog token field and a STA info list containing a plurality of entries are provided. In the sounding dialog token, a NDPA variant subfield having different possible values is included. Each possible value is associated with a different NDPA frame variant.

### CROSS-REFERENCE TO RELATED APPLICATIONS

This application claims priority to U.S. Provisional Patent Application No. 63/712,208, filed Oct. 25, 2024, entitled “Method and System for UHR NDPA Signalling”, and to U.S. Provisional Patent Application No. 63/712,763 filed on Oct. 28, 2024, entitled “Method and System for UHR NDPA Signalling”. The entire contents of U.S. Ser. No. 63/712,208 and U.S. Ser. No. 63/712,763 are incorporated herein by reference.

### TECHNICAL FIELD

The present disclosure pertains to the field of communication networks, and in particular to methods and systems for Ultra-High Reliability (UHR) Null Data Physical Layer Protocol Data Unit (PPDU) Announcement (NDPA) signalling in a communication network.

### BACKGROUND

The current NDPA frame format in the IEEE 802.11be (11be) draft lacks available space in the NDPA Announcement frame to accommodate new variants such as UHR or future NDPA frame versions. It is currently limited to supporting the following amendments: Very High Throughput (VHT) NDPA, High Efficiency (HE) NDPA, Ranging NDPA, and Extremely High Throughput (EHT) NDPA, making it incompatible with future amendments and versions of NDPA variants, hindering further development.

Therefore, there is a need for methods and systems for computation offloading that obviate or mitigate one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

Aspects of the present disclosure provide for a method for indicating a Wi-Fi™ standard in a null data physical layer protocol data unit announcement (NDPA) frame. The method comprises forming the NDPA frame. The NDPA frame includes a sounding dialog token field and a STA info list containing a plurality of entries. The sounding dialog token field includes a NDPA variant subfield having a value of ‘0’, ‘1’, ‘2’, or ‘3’. The NDPA variant subfield value of ‘0’ indicates that the NDPA frame includes a Special Common NDPA station (STA) info field and a Coordinated Beamforming (Co-BF) NDPA info field. The Special Common NDPA STA info field includes a Special Association Identifier (AID) field, an NDPA Extended Variant Type field, an extended Co-BF NDPA info flag, reserved bits and a disambiguation bit. The extended Co-BF NDPA info field is included to indicate a presence of a Co-BF NDPA Info field. A Co-BF NDPA Info is used to carry the necessary information for the shared AP to be used for NDP transmission and sounding process. When a Punctured Channel info field is three bits in length, the Co-BF NDPA info field includes a three-bit bandwidth (BW) field, the Punctured Channel info field, a two-bit Guard Interval (GI) and Ultra-High Reliability-Long Training Field (UHR-LTF) type field, a three-bit number of spatial streams (NSS) field, a first disambiguation bit, a seven-bit Transmit Opportunity (TXOP) field, a seven-bit Transmission Error Vector Magnitude TXEVM field, a one-bit number of Long Training Fields (LTFs) field, a second disambiguation bit, a three-bit Starting of spatial stream (SS) field, and a one-bit sounding type field. When the Punctured Channel info field is five bits in length, the Co-BF NDPA info field includes the three-bit BW field, the Punctured Channel info field, a one-bit GI and UHR-LTF type field, a two-bit NSS field, the first disambiguation bit, the seven-bit TXOP field, the seven-bit TXEVM field, the one-bit number of LTFs, the second disambiguation bit, the three-bit Starting of spatial stream (SS) field, and the one-bit sounding type field. Alternatively, when the Punctured Channel info field is five bits in length, the Co-BF NDPA info field includes the three-bit BW field, the Punctured Channel info field, the three-bit Starting of spatial stream (SS) field, the first disambiguation bit, a three-bit NSS field, a two-bit GI and UHR-LTF type field, the two-bit number of LTFs, the seven-bit TXEVM field, the one-bit sounding type field, the second disambiguation bit, and a four-bit reserved field, the STAs being configured to infer the TXOP duration from the Duration field in a MAC Header or from a Null Data Packet (NDP) Preamble. The NDPA frame is a Very High Throughput (VHT) NDPA frame when the value of the NDPA variant subfield is equal to ‘0’ and when the sounding dialog token field is followed by an entry of the plurality of entries in the STA info list includes an Association Identifier (AID) that has a value comprised between 1 and 2007. The NDPA frame is an Ultra-High Reliability (UHR) or beyond NDPA frame when the value of the NDPA variant subfield is equal to ‘0’ and when the sounding dialog token field is followed by an entry of the plurality of entries in the STA info list that includes a Special AID that has a value comprised between 2008 and 2047. The method further comprises transmitting the NDPA frame.

Aspects of the present disclosure provide for a method for indicating a Wi-Fi™ standard in a null data physical layer protocol data unit announcement (NDPA) frame. The method comprises forming the NDPA frame. The NDPA frame includes a sounding dialog token field and a STA info list containing a plurality of entries. The sounding dialog token field includes a NDPA variant subfield having a value of ‘0’, ‘1’, ‘2’, or ‘3’. The NDPA variant subfield value of ‘0’ indicates that the NDPA frame includes a Special NDPA station (STA) info field. When a Punctured Channel info field is three bits in length, the Special NDPA STA info field includes, in sequence, a Special Association Identifier (AID) field, an NDPA Extended Variant Type field, a bandwidth (BW) field, the punctured channel info field, a starting of spatial stream (SS) field, a number of spatial streams (NSS) field, a disambiguation bit, a Guard Interval (GI) and Ultra-High Reliability-Long Training Field (UHR-LTF) type field, a number of LTFs field, and a sounding type field. Alternatively, when the Punctured Channel info field is five bits in length, the Special NDPA STA info field including, in sequence, the Special AID field, the NDPA Extended Variant Type field, the bandwidth (BW) field, the punctured channel info field, the starting of spatial stream (SS) field, the GI and UHR-LTF type field, the disambiguation bit, the number of spatial streams (NSS) field, the number of LTFs field, and the sounding type field. The NDPA frame is a Very High Throughput (VHT) NDPA frame when the value of the NDPA variant subfield is equal to ‘0’ and when the sounding dialog token field is followed by an entry of the plurality of entries in the STA info list includes an Association Identifier (AID) that has a value comprised between 1 and 2007. The NDPA frame is an Ultra-High Reliability (UHR) or beyond NDPA frame when the value of the NDPA variant subfield is equal to ‘0’ and when the sounding dialog token field is followed by an entry of the plurality of entries in the STA info list includes a Special AID that has a value comprised between 2008 and 2047. The method further comprises transmitting the NDPA frame.

Aspects of the present disclosure provide for a method for indicating a Wi-Fi™ standard in a null data physical layer protocol data unit announcement (NDPA) frame. The method comprises forming the NDPA frame. The NDPA frame includes a sounding dialog token field and a Special NDPA STA info field. The sounding dialog token field includes a NDPA variant subfield having a value of ‘0’, ‘1’, ‘2’, or ‘3’. The NDPA variant subfield value of ‘2’ or ‘3’ indicates that the NDPA frame includes a Special NDPA station (STA) field that contains a Special Association Identifier (AID). When the value of the NDPA variant subfield value is ‘2’ or ‘3’ and when the sounding dialog token field is followed by the Special AID has a value comprised between 2008 and 2047, the NDPA frame is an Ultra-High Reliability (UHR) or beyond NDPA frame. When a Punctured Channel info field is three bits in length, the Special Common NDPA STA info field includes, in sequence, the Special AID field, an Extended NDPA Variant field, a bandwidth (BW) field, the Punctured Channel info field, a starting of spatial stream (SS) field, a number of spatial streams (NSS) field, a disambiguation bit, a Guard Interval (GI) and Ultra-High Reliability-Long Training Field (UHR-LTF) type field, a number of LTFs field and a Sounding Type field. Alternatively, when the Punctured Channel info field is five bits in length, the Special NDPA STA info field including, in sequence, the Special AID field, the Extended NDPA Variant field, a BW field, the Punctured Channel info field, the SS field, the NSS field, the disambiguation bit, the Sounding Type field, the GI and UHR-LTF type field, and the number of LTFs field. The method further comprises transmitting the NDPA frame.

Aspects of the present disclosure provide for a method for a sharing or coordinating access point (AP) to indicate, to a shared or coordinated AP or a basic service set (BSS), a Wi-Fi™ standard in a null data physical layer protocol data unit announcement (NDPA) frame. The method comprises forming the NDPA frame. The NDPA frame includes a sounding dialog token field and a STA info list containing a plurality of entries. The sounding dialog token field includes a NDPA variant subfield having a value of ‘0’, ‘1’, ‘2’, or ‘3’. The NDPA variant subfield value of ‘0’ indicates that the NDPA frame includes a Special Common NDPA station (STA) info field that contains a Special Association Identifier (AID). The NDPA frame is a Very High Throughput (VHT) NDPA frame when the value of the NDPA variant subfield is equal to ‘0’ and when the sounding dialog token field is followed by an entry of the plurality of entries in the STA info list includes an Association Identifier (AID) that has a value comprised between 1 and 2007. The NDPA frame is an Ultra-High Reliability (UHR) or beyond NDPA frame when the value of the NDPA variant subfield is equal to ‘0’ and when the sounding dialog token field is followed by an entry of the plurality of entries in the STA info list includes a Special AID that has a value comprised between 2008 and 2047. The method also comprises assigning, to the coordinated AP/BSS, a twelve-bit AP/BSS identifier (ID). The method also comprises including the twelve-bit AP/BSS ID at a beginning of an entry of the plurality of entries, the entry further comprising a three-bit number of Spatial Streams (NSS), a three-bit starting spatial stream, a two-bit Guard Interval (GI) and Ultra-High Reliability-Long Training Field (UHR-LTF) field, a seven-bit Tx EVM, a disambiguation bit at bit 27 and a one-bit or two-bit number of Long Training Fields (LTFs) field. When a Punctured Channel info field is three bits in length, the Special Common NDPA STA info field including the Special AID field, the NDPA Extended Variants types field, a bandwidth (BW) field, a Transmit Opportunity (TXOP) field or a reserved field, a disambiguation bit, the Punctured Channel Info field and a Sounding type field. Alternatively, when a Punctured Channel info field is three bits in length, the Special Common NDPA STA info field including the Special AID field, the NDPAExtended Variants types field, the Punctured Channel Info field, a Transmit Opportunity (TXOP) field or a reserved field, a disambiguation bit, the BW field and a Sounding type field. The method further comprises transmitting the NDPA frame.

Aspects of the present disclosure provide for a method for two or more access points (APs) to indicate, to a basic service set (BSS), a Wi-Fi™ standard in a null data packet physical layer protocol data unit announcement (NDPA) frame. The method comprises forming the NDPA frame. The NDPA frame includes a sounding dialog token field and a STA info list containing a plurality of entries. The sounding dialog token field includes a NDPA variant subfield having a value of ‘0’, ‘1’, ‘2’, or ‘3’. The NDPA variant subfield value of ‘2’ or ‘3’ indicates that the NDPA frame includes a Special Common NDPA station (STA) field that contains a Special Association Identifier (AID). When the NDPA variant subfield value is ‘2’ or ‘3’ and when the sounding dialog token field is followed by an entry of the plurality of entries in the STA info list includes an AID having a value comprised between 1 and 2007, the NDPA frame is a High-Efficiency (HE) NDPA frame or an Extremely High Throughput (EHT) NDPA frame. When the NDPA variant subfield value is ‘2’ or ‘3’ and when the sounding dialog token field is followed by an entry of the plurality of entries in the STA info list includes an AID or a Special AID having a value comprised between 2008 and 2047, the NDPA frame is an Ultra-High Reliability (UHR) or beyond NDPA frame. When a Punctured Channel info field is three bits in length, the Special Common NDPA STA info field includes the Special AID field, an NDPA Extended Variants types field, a bandwidth (BW) field, the Punctured Channel info field, a Transmit Opportunity (TXOP) field, a disambiguation bit, a reserved bit and a Sounding Type field. When the Punctured Channel info field is five bits in length, the Special Common NDPA STA info field includes the Special AID field, the NDPA Extended Variants types field, the Punctured Channel info field, the reserved bit, the TXOP field or reserved field, the disambiguation bit, the BW field and the Sounding Type field. When a particular AP, the particular AP being one of the two or more APs, signals sounding information to another of the two or more APs or to a Basic Service Set (BSS), the particular AP assigns an eleven-bit AP/BSS identifier (ID) to the other of the two or more APs or to the BSS. The method also comprises including the eleven-bit AP/BSS ID at a beginning of an entry of the plurality of entries of the STA info list, the entry further comprising a starting of Spatial Stream (SS) field, a number of Spatial Streams (NSS) field, a Tx EVM field, a reserved field, a GI AND UHR-LTF, disambiguation bit, a number of Long Training Fields (LTFs) field, and reserved bits. The method further comprises transmitting the NDPA frame.

Aspects of the present disclosure provide for a method for indicating a Wi-Fi™ standard in a null data physical layer protocol data unit announcement (NDPA) frame. The method comprises forming the NDPA frame. The NDPA frame includes a sounding dialog token field and a STA info list containing a plurality of entries. The sounding dialog token field includes a NDPA variant subfield having a value of ‘0’, ‘1’, ‘2’, or ‘3’. When the NDPA variant has the value ‘3’, the method comprises repurposing bit 20 (B20) of an entry of the plurality of entries of the STA info list to indicate whether the NDPA frame is an Extremely High Throughput (EHT) NDPA frame or an Ultra-High Reliability (UHR) NDPA frame. The method also comprises transmitting the NDPA frame.

Aspects of the present disclosure provide for a method for indicating a Wi-Fi™ standard in a null data physical layer protocol data unit announcement (NDPA) frame. The method comprises forming the NDPA frame. The NDPA frame includes a sounding dialog token field and a station (STA) info list containing a plurality of entries. The sounding dialog token field includes a NDPA variant subfield having a value of ‘0’, ‘1’, ‘2’, or ‘3’. When the NDPA variant has the value ‘3’, the method comprises repurposing bit 20 (B20) of an entry of the plurality of entries of the STA info list to indicate whether the NDPA frame is an Extremely High Throughput (EHT) NDPA frame or an Ultra-High Reliability (UHR) NDPA frame. The method also comprises including, in the NDPA frame, a shared access point (AP)/basic service set (BSS) STA info field. When a Punctured Channel info field is three bits in length, the shared AP/BSS STA info field includes a Special Association Identifier (AID) field, a bandwidth (BW) field, the Punctured Channel info field, a starting of Spatial Stream (SS) field, a TXOP or Tx EVM field, a disambiguation bit, a number of Long Training Fields (LTFs) field, a number of SS field and a GI and UHR-LTF type field. Alternatively, when a Punctured Channel info field is three bits in length, the shared AP/BSS STA info field includes the Special AID field, the BW field, the number of SS field, the starting of SS field, the TXOP or Tx EVM field, the disambiguation bit, the GI and UHR-LTF type field, the number of LTFs field and the Sounding Type field, and the entry of the plurality of entries of the STA info list that has the repurposed B20 including the Punctured Channel info field. When the Punctured Channel info field is five bits in length, the shared AP/BSS STA info field includes an AP/BSS AID field, the BW field, the Punctured Channel info filed, the starting of SS field, the TXOP or Tx EVM or reserved bits, the disambiguation bit, the number of LTFs field, the number of SS field and the GI and UHR-LTF type field. The method further comprises transmitting the NDPA frame.

When a Punctured Channel info field is three bits in length, method for indicating a Wi-Fi™ standard in a null data physical layer protocol data unit announcement (NDPA) frame. The method comprises forming the NDPA frame. The NDPA frame includes a sounding dialog token field, a Special Common NDPA STA info field, a Coordinated Beamforming (Co-BF) NDPA info field, and a STA info list containing a plurality of entries. The sounding dialog token field includes a NDPA variant subfield having a value of ‘0’, ‘1’, ‘2’, or ‘3’. When the NDPA variant has the value ‘0’ and when the sounding dialog token field is followed by an entry of the plurality of entries has an Association Identifier (AID) field with a value comprised between 1 and 2007, the NDPA frame is a Very High Throughput (VHT) NDPA frame. When the NDPA variant has the value ‘0’ and when the sounding dialog token field is followed by the entry of the plurality of entries has an Association Identifier (AID) field has a value comprised between 2008 and 2047, the NDPA frame is an Ultra-High Reliability (UHR) or beyond NDPA frame. The Special Common NDPA STA info field includes a Special AID field, an NDPA Extended Variant Types field, a Co-BF NDPA info flag, reserved bits, a disambiguation bit and further reserved bits. Alternatively, the Special Common NDPA STA info field includes the Special AID field, the NDPA Extended Variant Types field, the Co-BF NDPA info flag, reserved bits, a bandwidth (BW) field, a Punctured Channel info field, a disambiguation bit, a Sounding Type field and additional reserved bits. The Co-BF NDPA info field includes a shared AP/Basic Service Set (BSS) color, the Punctured Channel info field, a disambiguation bit, a starting of spatial stream (SS) field, a number of SS field, a GI and UHR-LTF type field, a Tx EVM field, a number of Long Training Fields (LTFs) field, a further disambiguation bit, the Sounding Type. Alternatively, the Co-BF NDPA info field includes the shared AP/BSS color, the starting SS field, the GI and UHR-LTF type field, the disambiguation bit, the number of SS field, the Tx EVM field, the number of LTFs field, reserved bits, the further disambiguation bit and further reserved bits. The method further includes transmitting the NDPA frame.

Other aspects of the disclosure provide for apparatus, and systems configured to implement the methods according to the first aspect disclosed herein. Various components can be configured with machine readable memory containing instructions, which when executed by the processors of these devices, configure the device to perform one or more of the methods and systems described herein.

Embodiments have been described above in conjunction with aspects of the present disclosure upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present disclosure will become apparent from the following detailed description, taken in combination with the appended drawings, in which:

FIG. 1 is a schematic illustration of an NDPA frame format, according to prior art.

FIG. 2 is a schematic illustration of an NDPA Sounding Dialog Token field format, according to prior art.

FIG. 3 is a schematic illustration of a bit settings for NDPA Sounding Dialog Token field format, according to prior art.

FIG. 4 is a schematic illustration of an NDP Announcement frame that includes the Sounding Dialog Token field, according to an embodiment of the present disclosure.

FIG. 5 is a schematic illustration of a Special Common NDPA STA Info field, according to an embodiment of the present disclosure.

FIG. 6 is a schematic illustration of a Co-BF NDPA STA Info field format, according to an embodiment of the present disclosure.

FIG. 7 is a schematic illustration of a Co-BF NDPA STA Info field format, according to another embodiment of the present disclosure.

FIG. 8 is a schematic illustration of a Co-BF NDPA STA Info field format, according to another embodiment of the present disclosure.

FIG. 9 is a schematic illustration of a VHT and UHR STAs included in the NDPA frame, according to an embodiment of the present disclosure.

FIG. 10 is a schematic illustration of an NDP Announcement frame that includes the Sounding Dialog Token field, according to another embodiment of the present disclosure.

FIG. 11 is a schematic illustration of a Special NDPA STA Info field, according to an embodiment of the present disclosure.

FIG. 12 is a schematic illustration of a Special NDPA Variant STA Info field, according to another embodiment of the present disclosure.

FIG. 13 is a schematic illustration of a VHT and UHR STAs included in the NDPA frame, according to another embodiment of the present disclosure.

FIG. 14 is a schematic illustration of an NDP Announcement frame that includes the Sounding Dialog Token field, according to another embodiment of the present disclosure.

FIG. 15 is a schematic illustration of a Special NDPA Variant STA Info field, according to another embodiment of the present disclosure.

FIG. 16 is a schematic illustration of a Special NDPA Variant STA Info field, according to another embodiment of the present disclosure.

FIG. 17 is a schematic illustration of a Special NDPA Variant STA Info field, according to another embodiment of the present disclosure.

FIG. 18 is a schematic illustration of an HE and UHR STAs or EHT and UHR STAs included in the NDPA frame, according to an embodiment of the present disclosure.

FIG. 19 is a schematic illustration of an NDP Announcement frame that includes the Sounding Dialog Token field, according to another embodiment of the present disclosure.

FIG. 20 is a schematic illustration of a Special Common NDPA STA Info field, according to another embodiment of the present disclosure.

FIG. 21 is a schematic illustration of a shared AP/BSS Info field format, according to an embodiment of the present disclosure.

FIG. 22 is a schematic illustration of a Special NDPA Variant STA Info field, according to another embodiment of the present disclosure.

FIG. 23 is a schematic illustration of a Special Common NDPA STA Info field, according to another embodiment of the present disclosure.

FIG. 24 is a schematic illustration of a shared AP/BSS Info field format, according to another embodiment of the present disclosure.

FIG. 25 is a schematic illustration of a Special NDPA Variant STA Info field, according to another embodiment of the present disclosure.

FIG. 26 is a schematic illustration of an NDP Announcement frame that includes the Sounding Dialog Token field, according to another embodiment of the present disclosure.

FIG. 27 is a schematic illustration of a format showing repurpose reserved bit B20 in the STA Info field to signal for the UHR STAs whether the NDPA variant is EHT or UHR, according to an embodiment of the present disclosure.

FIG. 28 is a schematic illustration of a UHR STA Info field format, according to an embodiment of the present disclosure.

FIG. 29 is a schematic illustration of an NDP Announcement frame that includes the Sounding Dialog Token field, according to another embodiment of the present disclosure.

FIG. 30 is a schematic illustration of a shared AP/BSS STA Info field information that can be included within the UHR STA Info list, according to an embodiment of the present disclosure.

FIG. 31 is a schematic illustration of a shared AP/BSS Info field format, according to another embodiment of the present disclosure.

FIG. 32 is a schematic illustration of an NDP Announcement frame that includes the Sounding Dialog Token field, according to another embodiment of the present disclosure.

FIG. 33 is a schematic illustration of a Special NDPA Variant STA Info field, according to another embodiment of the present disclosure.

FIG. 34 is a schematic illustration of a Co-BF NDPA STA Info field format, according to another embodiment of the present disclosure.

FIG. 35 is a schematic illustration of a Special NDPA Variant STA Info field, according to another embodiment of the present disclosure.

FIG. 36 is a schematic illustration of a Co-BF NDPA STA Info field format, according to another embodiment of the present disclosure.

FIG. 37 is a schematic illustration of an UHR STA Info field, according to another embodiment of the present disclosure.

FIG. 38 is a schematic illustration of example 4-byte, 6-byte and 8-byte STA Info field formats, according to an embodiment of the present disclosure.

FIG. 39 is a schematic illustration of example 4-byte and 8-byte STA Info field formats, according to another embodiment of the present disclosure.

FIG. 40 is a schematic illustration of a Co-BF NDPA STA Info field format, according to another embodiment of the present disclosure.

FIG. 41 is a schematic illustration of a Special NDPA Variant STA Info field, according to another embodiment of the present disclosure.

It will be noted that throughout the appended drawings, like features are identified by like reference numerals.

### DETAILED DESCRIPTION

The present disclosure sets forth various embodiments via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof. As used herein, the term “about” should be read as including variation from the nominal value, for example, a +/−10% variation from the nominal value. It is to be understood that such a variation is always included in a given value provided herein, whether or not it is specifically referred to. The phrase “in embodiments” can be interpreted to mean “in one or more, but not necessarily all embodiments.”

In scenarios with Overlapping Basic Service Sets (OBSSs), coordinated beamforming between Access Points (APs) in overlapping basic service sets (OBSSs) may be used for improving network efficiency and minimizing interference. By sharing beamforming parameters, APs can enhance signal quality and optimize spatial resource reuse, which is especially important in dense Wireless Local Area Network (WLAN) environments. For coordinated beamforming to function effectively, it requires coordinated sounding between APs, where key parameters for UHR sounding are exchanged. These parameters include bandwidth (BW) for the Null Data Packet (NDP), punctured channel information, the number of Long Training Fields (NLTF) in the NDP, and the configuration of the P-matrix (which defines the size and structure of spatial streams). APs also need to agree on the starting stream index, the number of spatial streams (NSS), and the specific P-matrix rows to use for joint transmission. However, incorporating the UHR sounding parameters into the NDPA frame introduces challenges. The existing frame format lacks the space to include essential information for joint NDP operations, such as Guard Interval (GI) and Long Training Field (LTF) configurations, Transmit Opportunity (TXOP) duration, and Transmission Error Vector Magnitude (Tx EVM) details. These parameters are important for synchronized transmissions between coordinated APs but cannot be accommodated within the current NDP Announcement (NDPA) frame, which restricts the ability to implement coordinated beamforming in OBSS environments. As a result, there is a need to revise and expand the NDPA frame format to support the UHR and future NDPA variants with their new capabilities and features.

In this disclosure, several options to extend the Null-Data PPDU, or Packet, (NDP) Announcement frame format to accommodate the UHR and beyond variants by introducing a Special Common NDPA Info field within the NDPA frame are presented by way of non-limiting example embodiments. Additionally, a Co-BF NDPA Info field within the NDPA frame, which contains important UHR NDP sounding information and is addressed to all UHR AP/non-AP STAs within the coordinated OBSS is introduced.

In the prior art, the NDP Announcement frame has four variants, the NDP Announcement frame, the HE NDP Announcement frame, the Ranging NDP Announcement frame, and the EHT NDP Announcement frame. The four formats are distinguished by the setting of the NDP Announcement Variant subfield in the Sounding Dialog Token field.

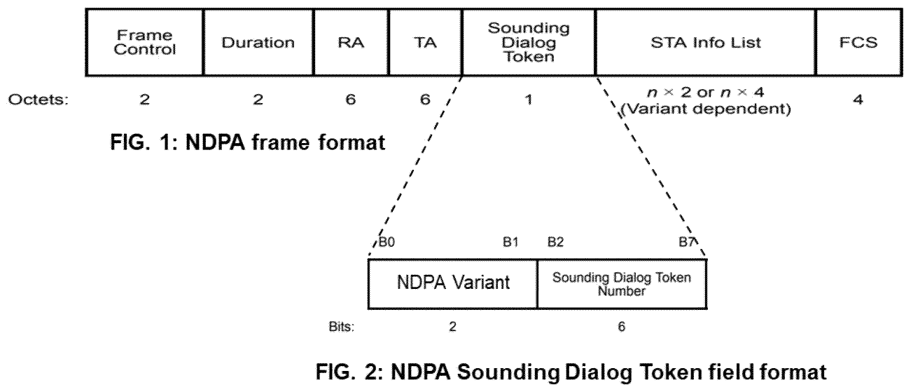

The frame format of the NDP Announcement frame is shown in FIG. 1 and FIG. 2. The Sounding Dialog Token subfield of FIG. 1 is shown in FIG. 2 as including an NDPA Variant subfield and a Sounding Dialog Token Number subfield. Table 1 lists examples of NDPA variant subfield valued and the corresponding NDPA frame variants.

TABLE 1
NDPA frame variant encoding

| NDPA variant subfield | NDP Announcement frame variant |
|---|---|
| 0 | VHT NDP Announcement frame |
| 1 | Ranging NDP Announcement frame |
| 2 | HE NDP Announcement frame |
| 3 | EHT NDP Announcement frame |

The Sounding Dialog Token Number subfield in the Sounding Dialog Token field contains a value to indicate how many NDPA frames are transmitted by the related AP.

The current NDPA frame format in the IEEE 802.11be (11be) standard draft lacks available space in the NDPA Announcement frame to accommodate new variants such as UHR or future NDPA frame versions. It is currently limited to supporting the following amendments: Very High Throughput (VHT) NDPA, High Efficiency (HE) NDPA, Ranging NDPA, and Extremely High Throughput (EHT) NDPA, making it incompatible with future amendments and versions of NDPA variants, hindering further development.

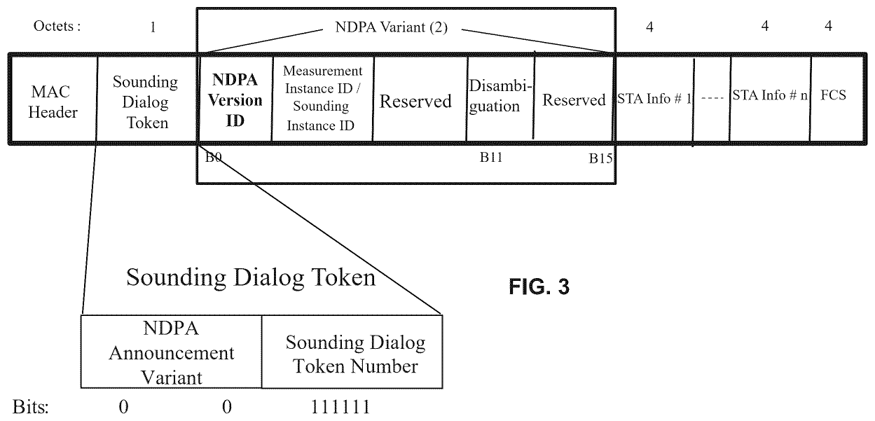

In IEEE 802.11-21/1977r0 standard, a method to extend the NDPA frame to include future amendments was introduced. As shown in FIG. 3, among the 8 bits in the Sounding Dialog Token field, the first two bits are always set to zero, while the remaining six bits are set to one. These bits help flag the presence of a new NDPA Variant field. This NDPA Variant field consists of 16 bits, numbered B0 to B15, and can be utilized for indicating the NDPA variant as well as other common information that may be introduced in future amendments, with the exception of bit B11. Bit B11 must be set as the Disambiguation subfield to prevent incorrect detection of the Association Identifier (AID) by VHT devices, ensuring compatibility across different device types. Additionally, some of the remaining bits in the NDPA Variant field can be allocated for indicating future NDPA variants, such as EHT+(Extremely High Throughput+), the Sensing Announcement Frame, or special NDPA frames like vendor-specific NDPA frames and information exchange frames between coordinated APs. A portion of these bits should be dedicated to the Sounding Dialog Token Number subfield which is moved from the Sounding Dialog Token field to the NDPA Variant field. All unused bits in the NDPA Variant field are reserved for future purposes, which could include common information such as bandwidth (BW) or preamble puncturing pattern indications for all recipient stations (STAs). Furthermore, one of the unused bits might be employed to indicate an extension of the NDPA Variant, allowing for further expansion and flexibility in future wireless communication standards.

The existing NDPA frame format in the IEEE 802.11be (11be) standard draft suffers from several limitations that hinder its ability to support future developments and new features in WLAN systems. Specifically, the current format lacks sufficient space in the NDPA Announcement frame to accommodate new NDPA variants, such as UHR, and future versions of NDPA frames. The format is currently designed to support only a limited number of existing amendments, including Very High Throughput (VHT) NDPA, High Efficiency (HE) NDPA, Ranging NDPA, and Extremely High Throughput (EHT) NDPA. This limitation constrains the adaptability of the NDPA frame to future Wi-Fi generations, preventing it from easily incorporating emerging technologies and features, particularly in advanced use cases such as coordinated beamforming (Co-BF) and coordinating sounding in Overlapping Basic Service Sets (OBSSs).

In the approach outlined in IEEE 802.11-21/1977r0 standard, the entire 8 bits in the Sounding Dialog Token field would be required to signal the presence of the NDPA variant. As a result, the 6 bits of the Sounding Dialog Token Number subfield are moved to be included in the new 16 bits NDPA variant field. This approach is considered suboptimal, as it repurposes the Sounding Dialog Token field beyond its intended scope, leading to design inefficiencies. The overuse of these bits increases signaling complexity and can lead to inefficient handling of future NDPA variants and their associated parameters. Additionally, in this design, the NDPA Variant field is defined as 16 bits; however, the allocation of these bits presents several challenges. Six of the 16 bits are reserved for the Sounding Dialog Token Number, which leaves only a limited number of bits to manage additional requirements. Specifically, only 3 or 4 bits are allocated for indicating the NDPA Variant, while 1 bit is reserved for the disambiguation subfield to avoid conflicts with legacy devices such as VHT stations. After these assignments, there are only 5 or 6 bits remaining, which is insufficient for including the critical parameters required for advanced features like coordinated beamforming. These features demand additional parameters such as bandwidth (BW) details, punctured channel information, the size of the Long Training Field (NLTF) in the NDP, number of spatial streams and starting stream index, sounding type, Guard Interval (GI) and UHR-LTF type, TXOP and Tx EVM parameters, and other Co-BF sounding details, which cannot be accommodated within the limited space. As a result, this design limits scalability, making it challenging to incorporate future amendments with their advanced capabilities, ultimately restricting the overall evolution of the Wi-Fi™ standard.

The present disclosure addresses several technical challenges associated with the current NDPA frame format, particularly as it relates to the introduction of new variants such as Ultra-High Reliability (UHR) and other future amendments.

According to one key technical problem, there is insufficient space for New NDPA Variants. The existing NDPA frame format in IEEE 802.11be format lacks the necessary space to accommodate future NDPA variants like UHR. The lack of the available space in the NDPA Announcement frame prevents the addition of critical parameters needed for UHR operations and other future enhancements, which restricts the evolution of the standard to meet the demands of advanced WLAN applications.

According to another key technical problem, there is a lack of ability to Support Coordinated Sounding and Beamforming Coordination. Coordinated beamforming (Co-BF) between APs in Overlapping Basic Service Sets (OBSSs) requires the exchange of extensive sounding parameters, such as bandwidth (BW) information, punctured channel details, the number of Long Training Fields (NLTFs), and P-matrix configurations number of spatial streams and starting stream index, sounding type, Guard Interval (GI) and UHR-LTF type, TXOP and Tx EVM parameters, and other Co-BF sounding details. The current frame structure cannot accommodate these additional parameters, leading to limitations in achieving efficient and coordinated communication between APs.

According to another key technical problem, there is poor utilization of Sounding Dialog Token Field. The existing approach, which suggests using all 8 bits in the Sounding Dialog Token field to signal the presence of an NDPA variant, is considered inefficient. This design overburdens the token field, increasing signaling complexity and reducing the system's ability to handle future expansions of the NDPA variants, thereby affecting performance and flexibility.

According to another key technical problem, there is a lack of Common Information Sharing in Coordinated OBSSs. The current NDPA frame does not provide an effective mechanism for sharing UHR-specific information between APs and non-AP STAs within a coordinated OBSS. This limitation makes it difficult to facilitate seamless communication and coordination, which are critical for achieving ultra-high reliability and improved spatial reuse in dense network environments.

The present disclosure seeks to address one or more of these technical problems by proposing an enhanced NDPA frame format that extends its capabilities, optimizes field utilization, and introduces new mechanisms to support the efficient exchange of UHR-related information for improved performance in future wireless systems.

The present disclosure proposes a series of enhancements to the existing NDPA frame format to accommodate new Ultra-High Reliability (UHR) variants and other future amendments, while addressing the limitations of the current IEEE 802.11be standard draft.

One main feature of the present disclosure relates to an extension of the NDPA Frame Format. The present disclosure introduces modifications to the existing NDP Announcement frame to increase the available space for new NDPA variants. This includes optimizing the bit allocation within the frame to ensure it can carry additional information required for UHR and future NDPA amendments. By efficiently restructuring fields like the Sounding Dialog Token and NDPA Variant fields, the extended frame can handle new features while maintaining compatibility with legacy NDPA formats.

Another main feature of the present disclosure relates to an introduction of a UHR NDPA Co-BF Info Field. A dedicated UHR NDPA Co-BF Info field is introduced to address all Ultra-High Reliability-specific sounding information. This field enables coordinated or shared Access Points (APs) within Overlapping Basic Service Sets (OBSSs) to share critical parameters such as bandwidth (BW), punctured channel details, Long Training Field (NLTF) configuration, and P-matrix specifications including number of spatial streams (NSS) and starting of spatial stream, TXOP duration, and TX EVM parameters. This addition ensures that coordinated beamforming and other UHR-specific operations are adequately supported.

Another main feature of the present disclosure relates to supporting Future NDPA Variants. The present disclosure prepares the NDPA frame format for future expansions by introducing fields that can be reserved for future use, allowing for flexibility in accommodating emerging WLAN technologies. This ensures that the frame format remains scalable and capable of supporting future NDPA variants, such as UHR+ and Sensing Announcement Frames, without needing substantial revisions in the future.

The above noted modifications collectively ensure that the NDPA frame format is prepared for the evolving demands of wireless communication systems, particularly in supporting Ultra-High Reliability (UHR) and enabling more efficient coordinated communication between APs in dense OBSS environments.

The present disclosure is related to the standardization of next generation of IEEE 802.11bn standard and may be applicable to UHR APs and STAs, in particular, to Wi-Fi™ 8 APs or devices (Future devices).

The present disclosure discloses several options to extend the NDP Announcement frame to accommodate the UHR and beyond variants.

The present disclosure also introduces an UHR NDPA Co-BF Info field, which contains UHR sounding information and may be addressed to all UHR AP/non-AP STAs within the coordinated OBSS.

In a first example embodiment, a scenario of two APs only participating in a Co-BF coordination group is considered.

Utilizing a value of zero in the NDP Announcement Variant subfield to indicate the presence of a Special Common NDPA STA Info field, which can be used to signal UHR and future variants, may be a suitable option.

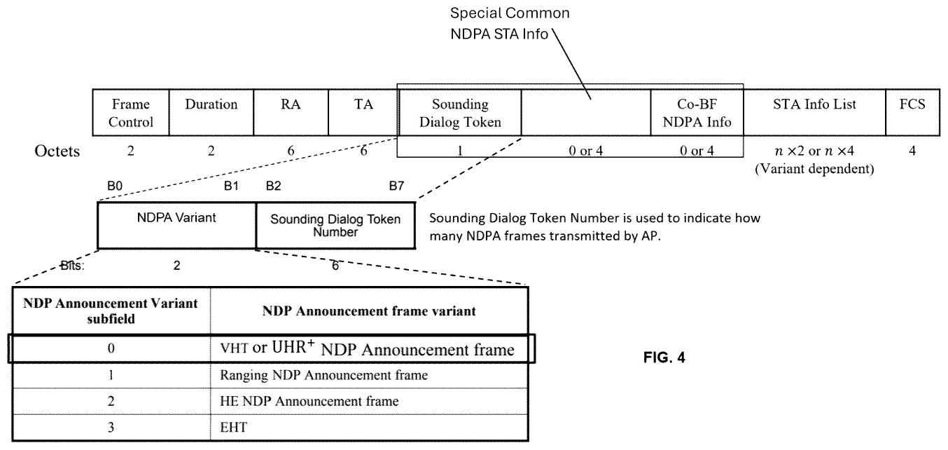

The proposed format of the NDP Announcement frame according to the first embodiment, including the Sounding Dialog Token field is as shown in FIG. 4. If the Sounding Dialog Token with NDP Announcement Variant subfield equal to zero is followed by a STA Info field containing an AID between 1 and 2007, this NDPA frame corresponds to the VHT variant. If the Sounding Dialog Token with NDP Announcement Variant subfield equals zero is followed by a STA Info field containing a Special AID greater than 2007 (a value between 2008 and 2047), the NDPA frame indicates a UHR or beyond variant.

The specific variant type for NDPA frame is indicated in the Extended NDPA Variant subfield within the Special Common NDPA STA Info field.

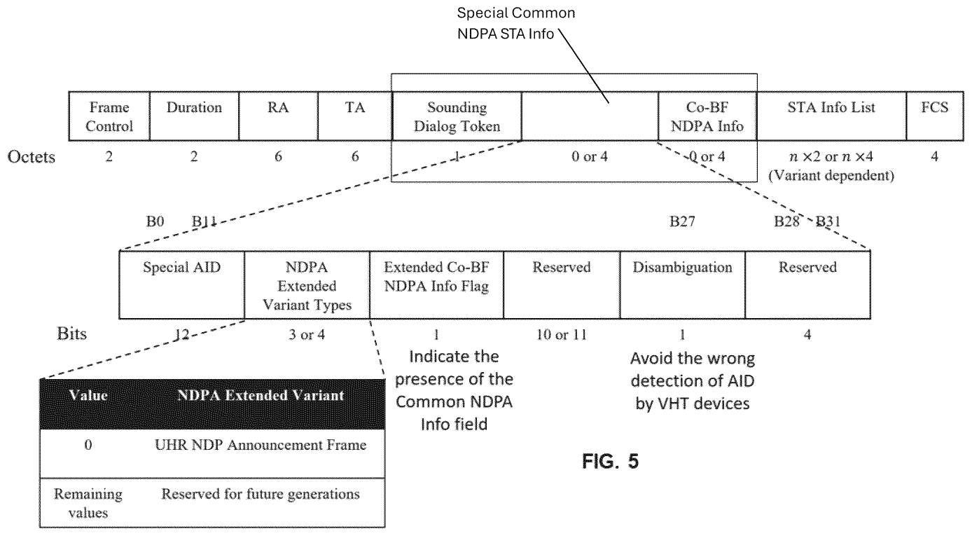

An example of the proposed format of the Special Common NDPA STA Info field is as shown in FIG. 5, in association with the first embodiment.

As illustrated in FIG. 5, the Special Common NDPA STA Info field, according to the first embodiment, includes A Special AID (12 bits), which value may be greater than 2007 (a value between 2008 and 2047). This value may be a fixed value defined in the standard or assigned value from the Sharing or Coordinating AP to the Shared or Coordinated AP in the OBSS. The Shared or Coordinated AP has to share this Special AID with its associated UHR non-AP STAs. Notably, AID 12 may be used for the UHR STA Info fields to align with that in the VHT variant. When the STA decodes the NDPA variant subfield as 0, it will interpret the first 12 bits in the STA Info field as an AID 12, just like in the VHT.

As further illustrated in FIG. 5, the Special Common NDPA STA Info field, includes NDPA Extended Variant Types (3 or 4 bits) to accommodate UHR and beyond variants. A value of 0 is used to indicate UHR NDPA Announcement frame. The remaining values of this subfield are kept reserved for future generations or applications, e.g., sensing, vendor-specific, etc.

As further illustrated in FIG. 5, the Special Common NDPA STA Info field, includes Extended Co-BF NDPA Info Flag (1 bit) to indicate the presence of the Co-BF NDPA Info field right after the Special NDPA Variant STA Info field.

As further illustrated in FIG. 5, the Special Common NDPA STA Info field, includes B27 that is the Disambiguation bit and is set to 1 to avoid the wrong detection of AID by VHT devices.

Other remaining bits in FIG. 5 are kept reserved or may be utilized for other TBD control information. Some of these reserved bits (e.g., B21 to B26) may be utilized as a Co-BF Instance Identifier (Co-BF Instance ID). This Co-BF Instance Identifier may be assigned from the Sharing or Coordinating AP to the Shared or Coordinated AP during the Multi-AP coordination negotiation process as a means of identification within their Co-BF coordination group. The inclusion of this Co-BF Instance Identifier within the Special Common NDPA field serves to indicate that the subsequent Co-BF Info field is intended for the Shared or Coordinated AP whose identifier aligns with the specified Co-BF Instance Identifier.

Such Co-BF NDPA Info field includes Bandwidth (3 bits), that is set to 0 for 20 MHz; set to 1 for 40 MHz; set to 2 for 80 MHz; set to 3 for 160 MHz; set to 4 for 320 MHz-e; and set to 5 for 320 MHz-2. Values 6 and 7 are Reserved. Such Co-BF NDPA Info field includes the Punctured Channel Info (3 bits) that may be formatted as shown in Table 2.

TABLE 2
Punctured Channel Info (3 bits) formatting

| | Punctured Channel Info (In an 80 MHz frequency |
|---|---|
| Value | subblock) |
| 0 | No puncturing |
| 1 | The lowest 20 MHz subchannel is punctured |
| 2 | Second lowest 20 MHz subchannel is punctured |
| 3 | Third lowest 20 MHz subchannel is punctured |
| 4 | Highest 20 MHz subchannel is punctured |
| 5 | Two lowest 20 MHz subchannels are punctured |
| 6 | Two highest 20 MHz subchannels are punctured |
| 7 | Second and Third lowest 20 MHz subchannels are |
| | punctured |

Such Co-BF NDPA Info field further includes Number of Spatial Streams (NSS) (3 bits); Starting Spatial Stream (Starting Stream Index) (3 bits) to determine which row in the Pre-coding P-matrix is used; and GI AND UHR-LTF Type (2 bits) that may be formatted as shown in Table 3.

TABLE 3
GI AND UHR-LTF Type (2 bits) formatting

| Value | GI AND UHR-LTF Type |
|---|---|
| 0 | 1 × UHR-LTF + 1.6 μs GI |
| 1 | 2 × UHR-LTF + 1.6 μs GI |
| 2 | 4 × UHR-LTF + 3.2 μs GI |
| 3 | Reserved |

Such Co-BF NDPA Info field further includes Number of LTF (N_LTF) (1 bit) that may be formatted as shown in Table 4.

TABLE 4
Number of LTF (N_LTF) (1 bit) formatting

| Value | N_LTF |
|---|---|
| 0 | 4 |
| 1 | 8 |

Such Co-BF NDPA Info field further includes Sounding Type (1 bit) that may be formatted as shown in Table 5.

TABLE 5
Sounding Type (1 bit) formatting

| Value | Sounding Type |
|---|---|
| 0 | Joint NDP |
| 1 | Sequential NDP |

Such Co-BF NDPA Info field further includes another prospective for the 1-bit sounding type, it may refer to TB-sounding (value 0) or Co-BF sounding (value 1); TXOP duration (7 bits); Tx EVM (7 bits). Its value may be presented in dBm unit; And bits B11 and B27 that are the Disambiguation bits and are set to 1 to avoid the wrong detection of AID by legacy devices, particularly the VHT devices.

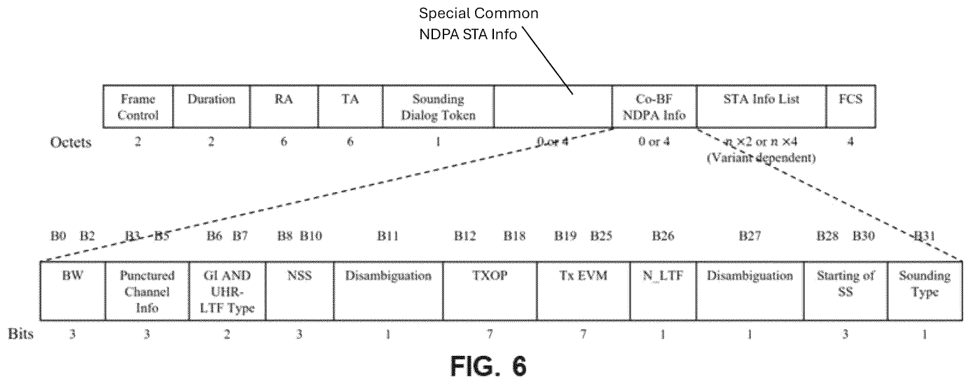

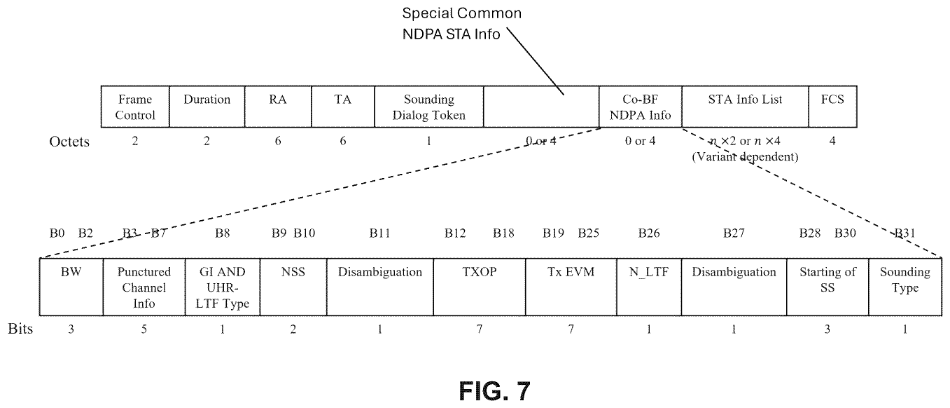

An example of a possible proposed format of the Co-BF NDPA STA Info field is shown in FIG. 6. Notably, the location of each previously defined subfield may be changed/moved in the 4-bytes Co-BF NDPA STA Info/Special Common NDPA Variant STA Info fields.

In an embodiment, another another way to formulate the GI AND UHR-LTF Type is to present it in 1 bit, formatted as shown in Table 6.

TABLE 6
An example of formulating the GI AND UHR-LTF Type

| Value | GI AND UHR-LTF Type |
|---|---|
| 1 | 2 × UHR-LTF + 1.6 μs GI |
| 2 | 4 × UHR-LTF + 3.2 μs GI |

Additionally, another way to formulate the NSS is to present it in 2 bits since the maximum number of spatial streams for each UHR AP/non-AP STA is 4.

As a result, one or two extra bit(s) can be saved, which can be used as extension for any of the listed parameters in the Co-BF NDPA STA Info field, utilized for another TBD control info parameter, flag the presence of extended Control Info field (if needed), or kept reserved.

Additionally, the Punctured Channel Info can also be formatted in 5 bits.

As for the TXOP duration, instead of embedding it within the UHR sounding parameters, STAs can infer the TXOP duration from the Duration field in the MAC Header or from the NDP Preamble. This saves extra bits to include other control info parameters.

Another way to formulate the NLTF is to present it in 2 bits to be formatted as shown in Table 7.

TABLE 7
An example of formulating the NLTF

| Value | N_LTF |
|---|---|
| 0 | 2 |
| 1 | 4 |
| 2 | 6 |
| 3 | 8 |

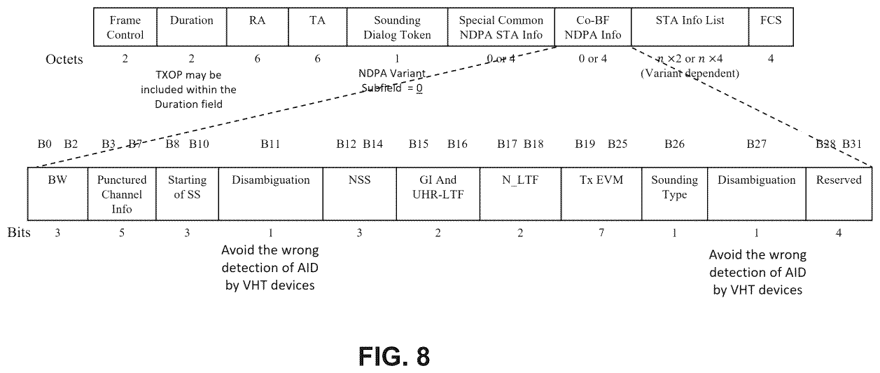

If the Punctured Channel Info field is formatted in 5 bits, one of the possible proposed formats of the Co-BF NDPA STA Info field is as shown in FIG. 8.

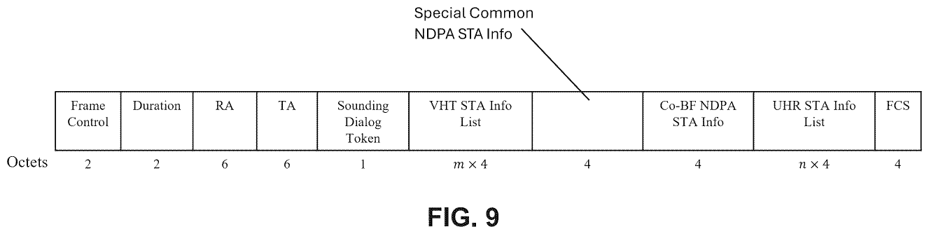

In case the VHT and UHR STAs are being included in the NDPA frame, one option is to list the VHT STA Info list immediately after the Sounding Dialog Token field, then include the Special NDPA Variant Info and the Common NDPA Info fields before the UHR STA Info list, as shown in FIG. 9.

In this case, the UHR STAs will initially process the frame as a VHT NDPA frame since the Sounding Dialog Token with NDP Announcement Variant subfield equals zero is followed by a STA Info field containing an AID between 1 and 2007. Once the UHR STAs decode the Special Common NDPA STA Info field, which includes a specific AID, they will then proceed to interpret the NDPA frame as a UHR variant.

In a second example embodiment, a scenario of two APs only participating in a Co-BF coordination group is considered.

In the second embodiment, rather than introducing two separate 4-byte fields—namely, the Special Common NDPA STA Info and the Co-BF NDPA STA Info fields, as outlined in the first embodiment above, —only a single “Special NDPA STA Info” field is proposed. This field will consolidate the Extended NDPA variants along with key UHR sounding parameters, simplifying the frame structure while ensuring the necessary information is still included.

As for the TXOP duration, with reference to the second embodiment, instead of embedding it within the UHR sounding parameters, STAs can infer the TXOP duration from the Duration field in the MAC Header or from the NDP Preamble. This saves extra bits to include other control info parameters.

Here a value of zero in the NDP Announcement Variant subfield is utilized to indicate the presence of a Special NDPA Variant STA Info field, which can be used to signal UHR and future variants as well as other important NDPA parameters.

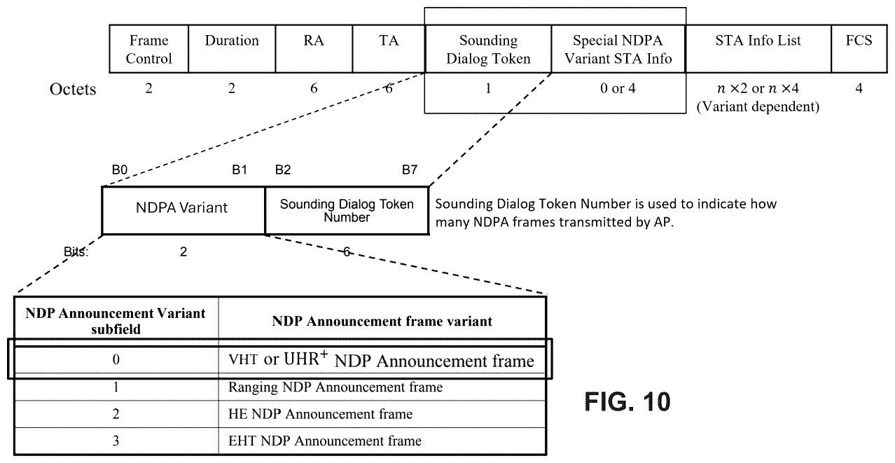

With reference to the second embodiment, the proposed format of the NDP Announcement frame, including the Sounding Dialog Token field is shown in FIG. 10.

If the Sounding Dialog Token with NDP Announcement Variant subfield equals zero is followed by a STA Info field containing an AID between 1 and 2007, then such NDPA frame corresponds to the VHT variant. If the Sounding Dialog Token with NDP Announcement Variant subfield equals zero is followed by a STA Info field containing a Special AID greater than 2007 (a value between 2008 and 2047), then the NDPA frame indicates a UHR or beyond variant.

The specific variant type for NDPA frame is indicated in the Extended NDPA Variant subfield within the Special NDPA Variant STA Info field.

Such Special NDPA STA Info field includes The Special AID (12 bits), which value may be greater than 2007 (a value between 2008 and 2047). This value may be a fixed value defined in the standard or assigned value from the Sharing or Coordinating AP to the Shared or Coordinated AP in the OBSS as an identification to their Co-BF coordination group. The Sharing or Coordinating AP and Shared or Coordinated AP have to share this Special AID with their associated UHR non-AP STAs. Notably, AID 12 is used for the UHR STA Info fields to align with that in the VHT variant. When the STA decodes the NDPA variant subfield as 0, it will interpret the first 12 bits in the STA Info field as an AID 12, just like in the VHT.

Such Special NDPA STA Info field further includes NDPA Extended Variant Types (3 bits) to accommodate UHR and beyond variants. Value of 0 is used to indicate UHR NDPA Announcement frame. The remaining values of this subfield are kept reserved for future generations or applications, e.g., sensing, vendor-specific, etc.

Such Special NDPA STA Info field further includes Bandwidth (3 bits), that can be set to 0 for 20 MHz; set to 1 for 40 MHz; set to 2 for 80 MHz; set to 3 for 160 MHz; set to 4 for 320 MHz-1; and set to 5 for 320 MHz-2. Values 6 and 7 are Reserved.

Such Special NDPA STA Info field further includes Punctured Channel Info (3 bits), formatted as in the first embodiment; Number of Spatial Streams (NSS) (3 bits); Starting Spatial Stream (Starting Stream Index) (3 bits) to determine which row in the Pre-coding P-matrix is used; GI AND UHR-LTF Type (2 bits), formatted as in the first embodiment; Number of LTF (N_LTF) (1 bit), formatted as in the first embodiment; Sounding Type (1 bit), formatted as in the first embodiment; And bit B27 as the Disambiguation bit that is set to 1 to avoid the wrong detection of AID by legacy devices, particularly the VHT devices.

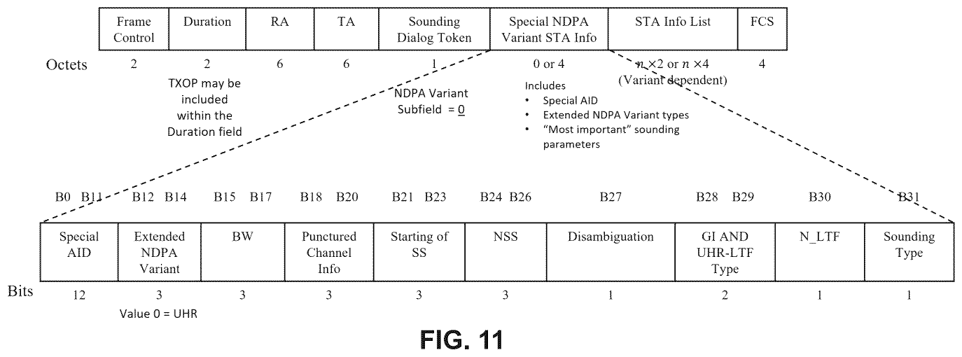

With reference to the second embodiment, one of the possible proposed example formats of the Special NDPA STA Info field is shown in FIG. 11.

Notably, the location of each previously defined subfield may be changed within this 4-bytes Common NDPA STA Info field.

If the GI AND UHR-LTF Type is presented in 1 bit and/or formulated NSS is presented in 2 bits, one or two extra bit(s) can be saved, which can be used as extension for any of the listed parameters in the Co-BF NDPA STA Info field, utilized for another TBD control info parameter, flag the presence of extended Control Info field (if needed), or kept reserved.

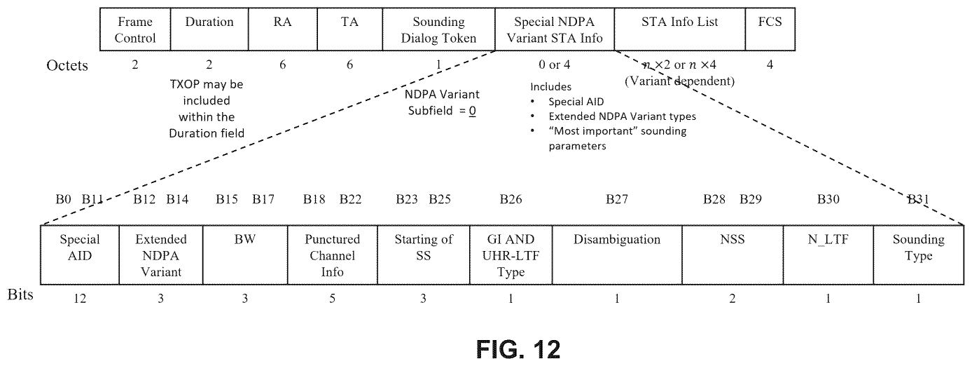

If the Punctured Channel Info field is formatted in 5 bits, one of the possible proposed formats of the Special NDPA Variant STA Info field is shown in FIG. 12.

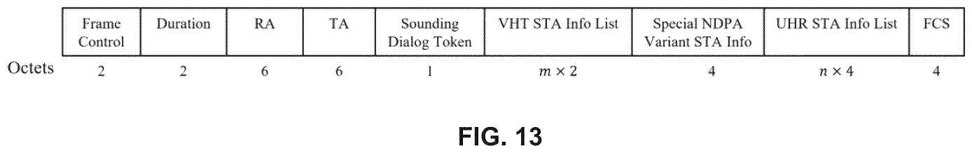

In case the VHT and UHR STAs are to be included in the NDPA frame, one option to list the VHT STA Info list immediately after the Sounding Dialog Token field, then include the Special NDPA Variant Info field before the UHR STA Info list, as shown in FIG. 13.

In this case, the UHR STAs will initially process the frame as a VHT NDPA frame since the Sounding Dialog Token with NDP Announcement Variant subfield equals zero is followed by a STA Info field containing an AID between 1 and 2007. Once the UHR STAs decode the Special NDPA Variant STA Info field, which includes a specific AID, they will then proceed to interpret the NDPA frame as a UHR variant.

In a third example embodiment, a scenario of two APs only participating in a Co-BF coordination group is considered.

In the third embodiment, rather than introducing two separate 4-byte fields—namely the Special Common NDPA STA Info and the Common NDPA STA Info fields, as outlined in the first embodiment, —only a single “Special NDPA STA Info” field is proposed. This field will consolidate the Extended NDPA variants along with key UHR sounding parameters, simplifying the frame structure while ensuring the necessary information is still included. As for the TXOP duration, instead of embedding it within the UHR sounding parameters, STAs can infer the TXOP duration from the Duration field in the MAC Header or from the NDP Preamble. This saves extra bits to include other control info parameters.

In the third embodiment, a value of two or three is utilized in the NDP Announcement Variant subfield to indicate the presence of a Special NDPA Variant STA Info field, which can be used to signal UHR and future variants as well as other important NDPA parameters.

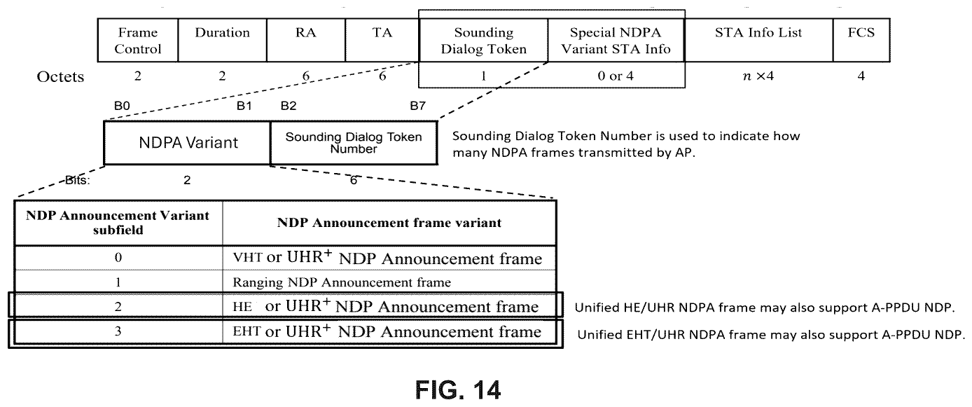

With reference to the third embodiment, the proposed format of the NDP Announcement frame, including the Sounding Dialog Token field, is shown in FIG. 14.

If the Sounding Dialog Token with NDP Announcement Variant subfield equals two or three is followed by a STA Info field containing an AID between 1 and 2007, then this NDPA frame corresponds to the HE variant or EHT variant, respectively. If the Sounding Dialog Token with NDP Announcement Variant subfield equals zero is followed by a STA Info field containing a Special AID greater than 2007 (a value between 2008 and 2047), then the NDPA frame indicates a UHR or beyond variant.

The specific variant type for NDPA frame is indicated in the Extended NDPA Variant subfield within the Special NDPA Variant STA Info field.

With reference to the third embodiment, such Special NDPA Variant STA Info field includes Special AID (11 bits), which value may be greater than 2007 (a value between 2008 and 2047). This value may be a fixed value defined in the standard or assigned value from the Sharing or Coordinating AP to the Shared or Coordinated AP in the OBSS as an identification to their Co-BF coordination group. The Sharing or Coordinating AP and Shared or Coordinated AP have to share this Special AID with their associated UHR non-AP STAs. Notably, AID 11 is used for the UHR STA Info fields to align with that in the HE or EHT variants. When the STA decodes the NDPA variant subfield as 0, it will interpret the first 11 bits in the STA Info field as an AID 11, just like in the HE or EHT.

Such Special NDPA Variant STA Info field further includes NDPA Extended Variant Types (3 bits) to accommodate UHR and beyond variants. Value of 0 is used to indicate UHR NDPA Announcement frame. The remaining values of this subfield are kept reserved for future generations or applications, e.g., sensing, vendor-specific, etc.

Such Special NDPA Variant STA Info field further includes Bandwidth (3 bits) that is set to 0 for 20 MHz; set to 1 for 40 MHz; set to 2 for 80 MHz; set to 3 for 160 MHz; set to 4 for 320 MHz-1; and set to 5 for 320 MHz-2. Values 6 and 7 are Reserved.

Such Special NDPA Variant STA Info field further includes Punctured Channel Info (3 bits), formatted as in the first embodiment; Number of Spatial Streams (NSS) (3 bits); Starting Spatial Stream (Starting Stream Index) (3 bits) to determine which row in the Pre-coding P-matrix is used; GI AND UHR-LTF Type (2 bits), formatted as in the first embodiment; Number of LTF (N_LTF) (1 bit), formatted as in the first embodiment; Sounding Type (1 bit), formatted as in the first embodiment; and bit B27 that is the Disambiguation bit and is set to 1 to avoid the wrong detection of AID by legacy devices, particularly the VHT devices.

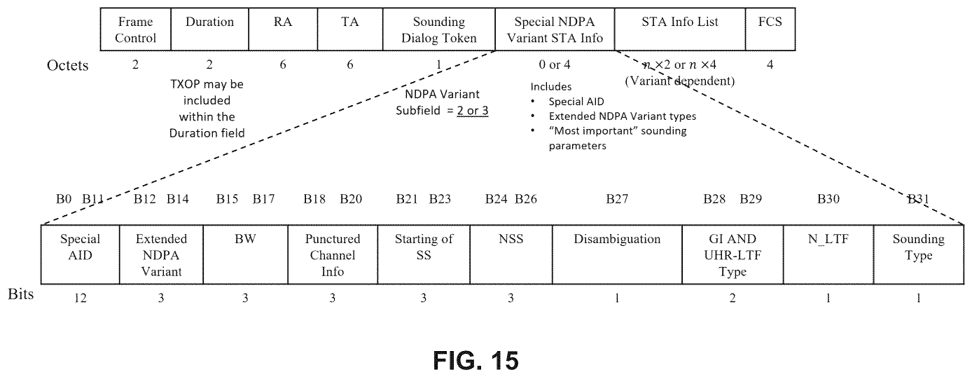

With reference to the third embodiment, one of the possible proposed formats of the Special NDPA Variant STA Info field is shown in FIG. 15.

Notably, the location of each previously defined subfield may be changed within this 4-bytes Common NDPA STA Info field.

If the GI AND UHR-LTF Type is presented in 1 bit or/and formulates NSS is presented in 2 bits, then one or two extra bit(s) can be saved, which can be used as extension for any of the listed parameters in the Co-BF NDPA STA Info field, utilized for another TBD control info parameter, flag the presence of extended Control Info field (if needed), or kept reserved.

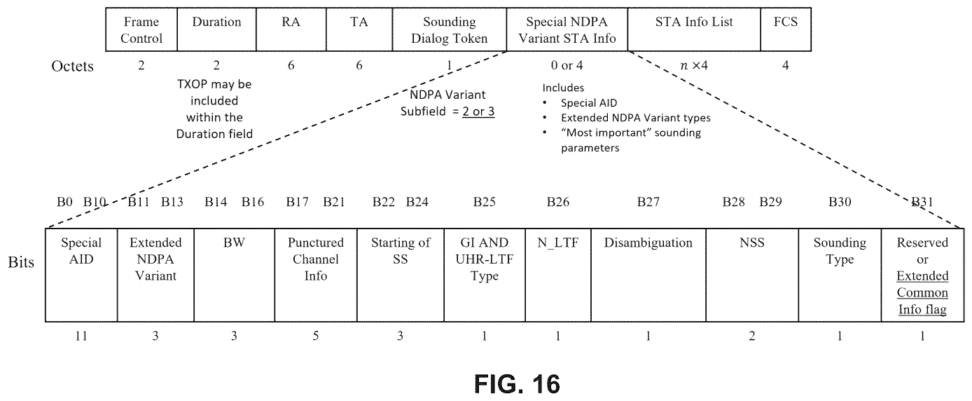

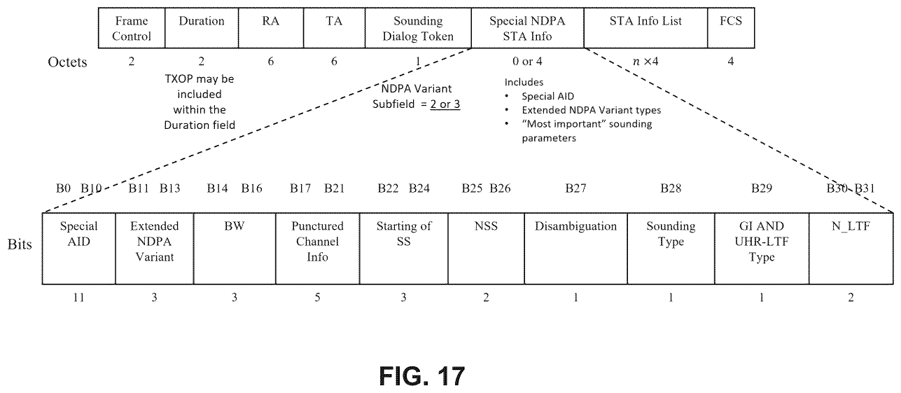

If the Punctured Channel Info field is formatted in 5 bits, one of the possible proposed formats of the Special NDPA Variant STA Info field is shown in FIG. 16. If the Punctured Channel Info field is formatted in 5 bits, another possible format of the Special NDPA Variant STA Info field is as shown in FIG. 17.

The third embodiment can support A-PPDU NDP (e.g., HE/[UHR or beyond] or EHT/[UHR or beyond] combinations).

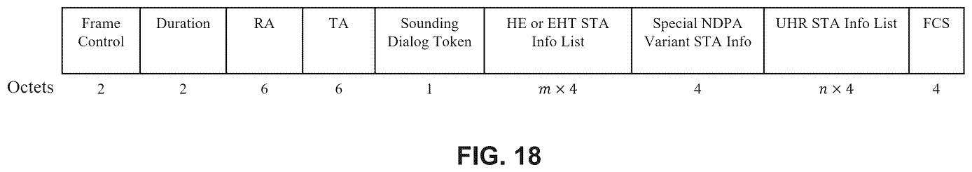

In case the HE and UHR STAs or EHT and UHR STAs are to be included in the NDPA frame, then one option to list the HE or EHT STA Info list immediately after the Sounding Dialog Token field, then include the Special NDPA Variant Info field before the UHR STA Info list, as shown in FIG. 18.

In this case, the UHR STAs will initially process the frame as an HE or EHT NDPA frame since the Sounding Dialog Token with NDP Announcement Variant subfield equals two or three, respectively, is followed by a STA Info field containing an AID between 1 and 2007. Once the UHR STAs decode the Special NDPA Variant STA Info field, which includes a specific AID, they will then proceed to interpret the NDPA frame as a UHR variant.

In the fourth embodiment, rather than considering that the Co-BF multi-AP coordination is between two APs only, as outlined in the first, second and third embodiments, —multi-AP Co-BF scenario is considered with at least 2 APs (≥2 APs) that are participating in this Co-BF coordination.

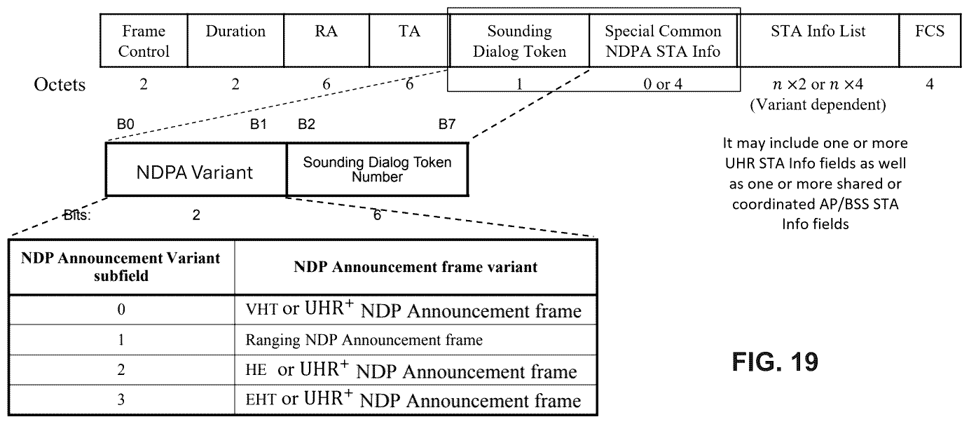

With reference to the fourth embodiment, the proposed format of the NDP Announcement frame, including the Sounding Dialog Token field is shown in FIG. 19.

In the fourth embodiment, a value of zero is utilized in the NDP Announcement Variant subfield to indicate the presence of a Special Common NDPA STA Info field, which can be used to signal UHR and future variants as well as other common NDPA parameters.

If the Sounding Dialog Token with NDP Announcement Variant subfield equals zero is followed by a STA Info field containing an AID between 1 and 2007, then this NDPA frame corresponds to the VHT variant. If the Sounding Dialog Token with NDP Announcement Variant subfield equals zero is followed by a STA Info field containing a Special AID greater than 2007 (a value between 2008 and 2047), then the NDPA frame indicates a UHR or Beyond variant.

The specific variant type for NDPA frame is indicated in the Extended NDPA Variant subfield within the Special Common NDPA STA Info field.

With reference to the fourth embodiment, such Special NDPA Variant STA Info field includes Special AID (12 bits), which value may be greater than 2007 (a value between 2008 and 2047). This value may be a fixed value defined in the standard.

Such Special NDPA Variant STA Info field further includes NDPA Extended Variant Types (3 bits) to accommodate UHR and beyond variants. Value of 0 is used to indicate UHR NDPA Announcement frame. The remaining values of this subfield are kept reserved for future generations or applications, e.g., sensing, vendor-specific, etc.

Such Special NDPA Variant STA Info field further includes Bandwidth (3 bits) that is set to 0 for 20 MHz; set to 1 for 40 MHz; set to 2 for 80 MHz; set to 3 for 160 MHz; set to 4 for 320 MHz-1; and set to 5 for 320 MHz-2. Values 6 and 7 are Reserved.

Such Special NDPA Variant STA Info field further includes Punctured Channel Info (3 bits), formatted as in the first embodiment; Sounding Type (1 bit), formatted as in the first embodiment; TXOP (7 bits) which bits may be utilized to indicate the TXOP duration or kept reserved (If it is kept reserved, the TXOP info may be included in the Duration field in the MAC Header); And B27 that is the Disambiguation bit and is set to 1 to avoid the wrong detection of AID by legacy devices, specially the VHT devices.

The remaining reserved bits can be used as extension for any of the listed parameters in the Common NDPA STA Info field, utilized for another TBD control info parameter, flag the presence of extended Common Info field (if needed), or kept reserved. Some of these reserved bits may be utilized as a Co-BF Instance Identifier (Co-BF Instance ID). This Co-BF Instance Identifier may be assigned from the Sharing or Coordinating AP to the Shared or Coordinated AP during the Multi-AP coordination negotiation process as a means of identification within their Co-BF coordination group.

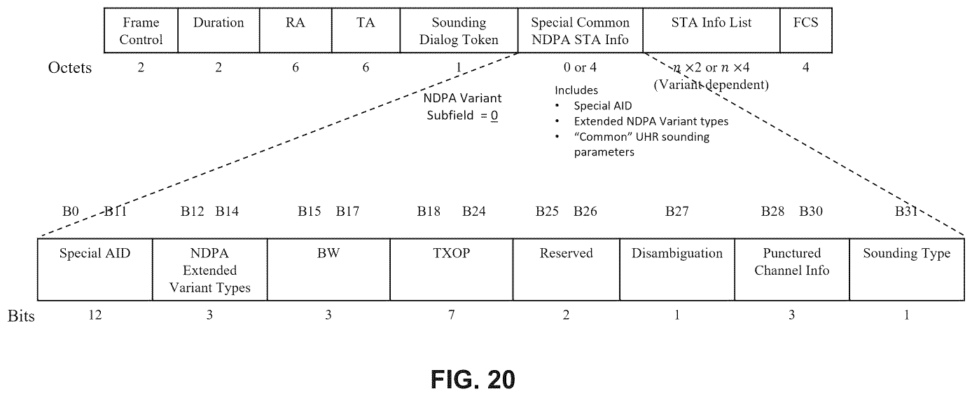

With reference to the fourth embodiment, one of the possible proposed formats of the Special Common NDPA STA Info field is shown in FIG. 20.

Notably, the location of each previously defined subfield may be changed within this 4-bytes Special Common NDPA STA Info field.

If the Sharing or Coordinating AP needs to signal specific sounding information to a particular Shared or Coordinated AP/BSS, it will assign a 12-bit AP/BSS ID to that Shared or Coordinated AP/BSS during the coordination setup phase. One of the 4-byte STA Info List entries will begin with the 12-bit Shared or Coordinated AP/BSS ID, and this field will contain the required sounding information to be communicated to the Shared or Coordinated AP/BSS.

With reference to the fourth embodiment, such example 4-byte Shared AP/BSS Info field will include Special AID (12 bits) which value may be greater than 2007 (a value between 2008 and 2047). This value may be an assigned value from the Sharing or Coordinating AP to the Shared or Coordinated AP in the OBSS. The Shared or Coordinated AP has to share this Special AID with its associated UHR non-AP STAs.

Such 4-byte Shared AP/BSS Info field will further include Number of Spatial Streams (NSS) (3 bits); Starting Spatial Stream (Starting Stream Index) (3 bits) to determine which row in the Pre-coding P-matrix is used; GI AND UHR-LTF Type (2 bits), formatted as in the first embodiment; Number of LTF (N_LTF) (1 bit), formatted as in the first embodiment; Tx EVM (7 bit), formatted as in the first embodiment; and bit B27 that is the Disambiguation bit and is set to 1 to avoid the wrong detection of AID by legacy devices, particularly the VHT devices.

The remaining reserved bits can be used as extension for any of the listed parameters in the shared AP/BSS Info field, utilized for another TBD control info parameter, flag the presence of extended Common Info field (if needed), or kept reserved.

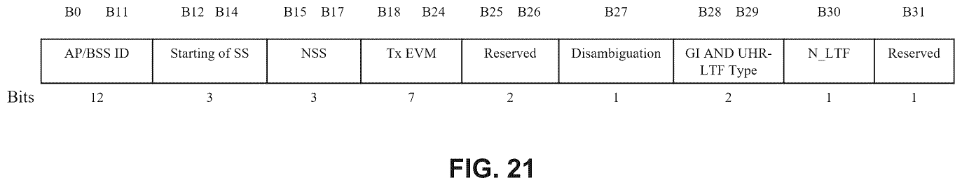

With reference to the fourth embodiment, one of the possible proposed formats of the shared AP/BSS Info field is shown in FIG. 21.

Notably, the location of each previously defined subfield may be changed within this 4-byte shared AP/BSS Info field.

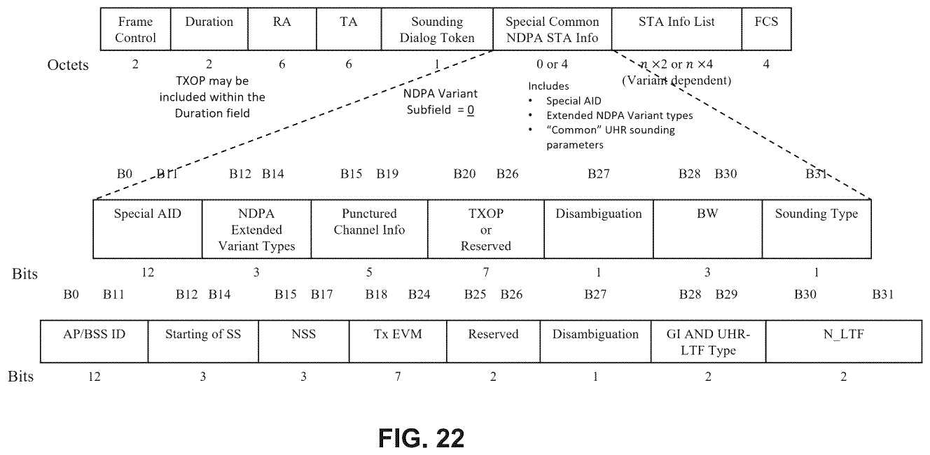

If the GI AND UHR-LTF Type is to be presented in 1 bit and/or the NSS is to be presented in 2 bits, then one or two extra bit(s) can be saved, which can be used as extension for any of the listed parameters in the Co-BF NDPA STA Info field, utilized for another TBD control info parameter, flag the presence of extended Control Info field (if needed), or kept reserved. If the Punctured Channel Info field is formatted in 5 bits, then one of the possible proposed formats of the Special NDPA Variant STA Info field is shown in FIG. 22.

In a fifth example embodiment, a multi-AP Co-BF scenario is considered with at least 2 APs (≥2 APs) that are participating in this Co-BF coordination, as in the fourth embodiment.

In the fifth embodiment, a value of two or three is utilized in the NDP Announcement Variant subfield to indicate the presence of a Special Common NDPA STA Info field, which can be used to signal UHR and future variants as well as other common NDPA parameters.

If the Sounding Dialog Token with NDP Announcement Variant subfield equals two or three is followed by a STA Info field containing an AID between 1 and 2007, then this NDPA frame corresponds to the HE or EHT variant, respectively. If the Sounding Dialog Token with NDP Announcement Variant subfield equals zero is followed by a STA Info field containing a Special AID greater than 2007 (a value between 2008 and 2047), then the NDPA frame indicates a UHR or Beyond variant.

The specific variant type for NDPA frame is indicated in the Extended NDPA Variant subfield within the Special Common NDPA STA Info field.

With reference to the fifth embodiment, such Special NDPA Variant STA Info field includes Special AID (11 bits) which value may be greater than 2007 (a value between 2008 and 2047). This value may be a fixed value defined in the standard.

Such Special NDPA Variant STA Info field further includes NDPA Extended Variant Types (3 bits) to accommodate UHR and beyond variants. A value of 0 is used to indicate UHR NDPA Announcement frame. The remaining values of this subfield are kept reserved for future generations or applications, e.g., sensing, vendor-specific, etc.

Such Special NDPA Variant STA Info field further includes Bandwidth (3 bits) that is set to 0 for 20 MHz; set to 1 for 40 MHz; set to 2 for 80 MHz; set to 3 for 160 MHz; set to 4 for 320 MHz-1; and set to 5 for 320 MHz-2. Values 6 and 7 are Reserved.

Such Special NDPA Variant STA Info field further includes Punctured Channel Info (3 bits), formatted as in the first embodiment; Sounding Type (1 bit), formatted as in the first embodiment; TXOP (7 bits) which bits may be utilized to indicate the TXOP duration or kept reserved (If it is kept reserved, the TXOP info may be included in the Duration field in the MAC Header); and bit B27 that is the Disambiguation bit and is set to 1 to avoid the wrong detection of AID by legacy devices, specially the VHT devices.

The remaining reserved bits can be used as extension for any of the listed parameters in the Common NDPA STA Info field, utilized for another TBD control info parameter, flag the presence of extended Common Info field (if needed), or kept reserved. Some of these reserved bits may be utilized as a Co-BF Instance Identifier (Co-BF Instance ID). This Co-BF Instance Identifier may be assigned from the Sharing or Coordinating AP to the Shared or Coordinated AP during the Multi-AP coordination negotiation process as a means of identification within their Co-BF coordination group.

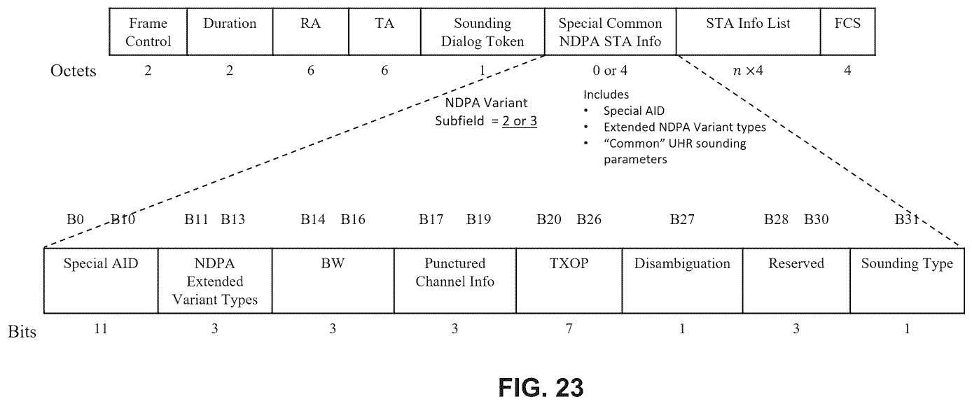

With reference to the fifth embodiment, one of the possible proposed formats of the Special Common NDPA STA Info field is shown in FIG. 23.

Notably, the location of each previously defined subfield may be changed within this 4-byte Special Common NDPA STA Info field.

Further with reference to the fifth embodiment, if the Sharing or Coordinating AP needs to signal specific sounding information to a particular Shared or Coordinated AP/BSS, then it will assign an 11-bit AP/BSS ID to that Shared or Coordinated AP/BSS during the coordination setup phase. One of the 4-byte STA Info List entries will begin with the 11-bit Shared or Coordinated AP/BSS ID, and this field will contain the required sounding information to be communicated to the Shared or Coordinated AP/BSS.

Such 4-byte Shared AP/BSS Info field will include Special AID (11 bits) which value may be greater than 2007 (a value between 2008 and 2047). This value may be an assigned value from the Sharing or Coordinating AP to the Shared or Coordinated AP in the OBSS. The Shared or Coordinated AP has to share this Special AID with its associated UHR non-AP STAs.

Such 4-byte Shared AP/BSS Info field will further include Number of Spatial Streams (NSS) (3 bits); Starting Spatial Stream (Starting Stream Index) (3 bits) to determine which row in the Pre-coding P-matrix is used; GI AND UHR-LTF Type (2 bits), formatted as in the first embodiment; Number of LTF (N_LTF) (1 bit), formatted as in the first embodiment; Tx EVM (7 bit), formatted as in the first embodiment; and bit B27 that is the Disambiguation bit and is set to 1 to avoid the wrong detection of AID by legacy devices, particularly the VHT devices.

The remaining reserved bits can be used as extension for any of the listed parameters in the shared AP/BSS Info field, utilized for another TBD control info parameter, flag the presence of extended Common Info field (if needed), or kept reserved.

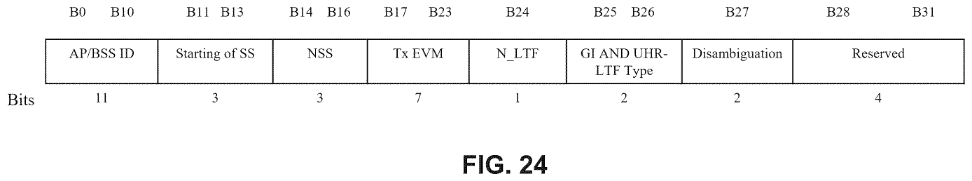

With reference to the fifth embodiment, one of the possible proposed formats of the shared AP/BSS Info field is as shown if FIG. 24.

Notably, the location of each previously defined subfield may be changed within this 4-byte shared AP/BSS Info field.

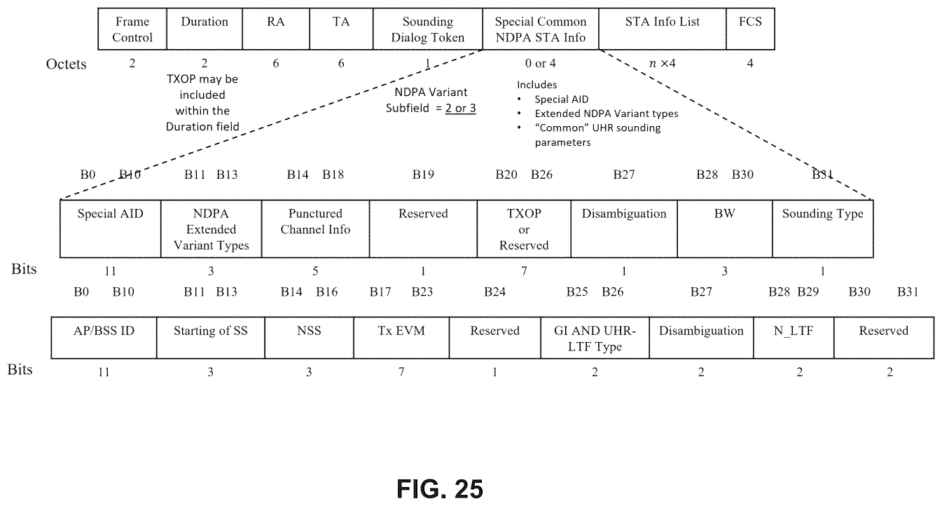

If the GI AND UHR-LTF Type is to presented it in 1 bit or/and formulate the NSS is presented in 2 bits, then one or two extra bit(s) can be saved, which can be used as extension for any of the listed parameters in the Co-BF NDPA STA Info field, utilized for another TBD control info parameter, flag the presence of extended Control Info field (if needed), or kept reserved. If the Punctured Channel Info field is formatted in 5 bits, then one of the possible proposed formats of the Special NDPA Variant STA Info field is shown in FIG. 25.

A sixth example embodiment pertains only to extending the NDPA frame to accommodate the UHR variant only.

As for the TXOP duration, STAs can infer the TXOP duration from the Duration field in the MAC Header or from the NDP Preamble.

In the sixth embodiment, a value of three is utilized in the NDP Announcement Variant subfield to indicate the NDPA variant could be EHT variant or UHR variant.

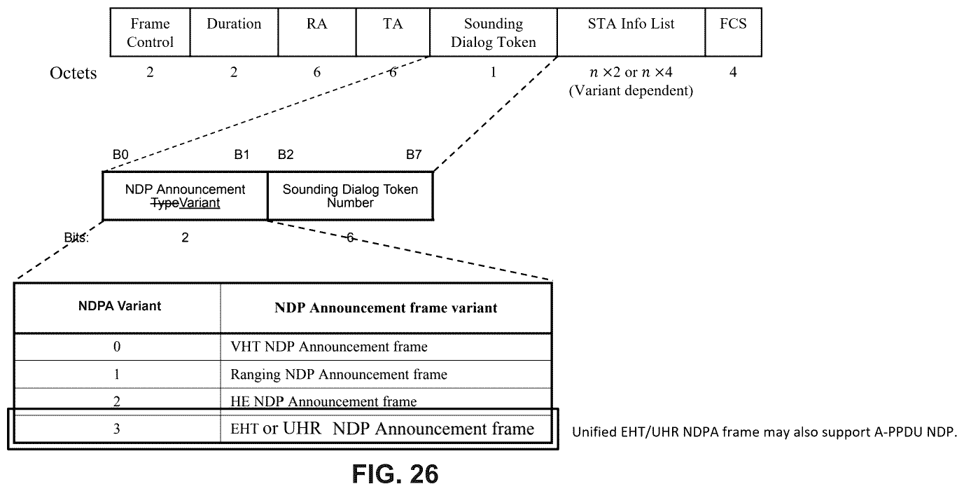

With reference to the sixth embodiment, the proposed format of the NDP Announcement frame, including the Sounding Dialog Token field is shown in FIG. 26.

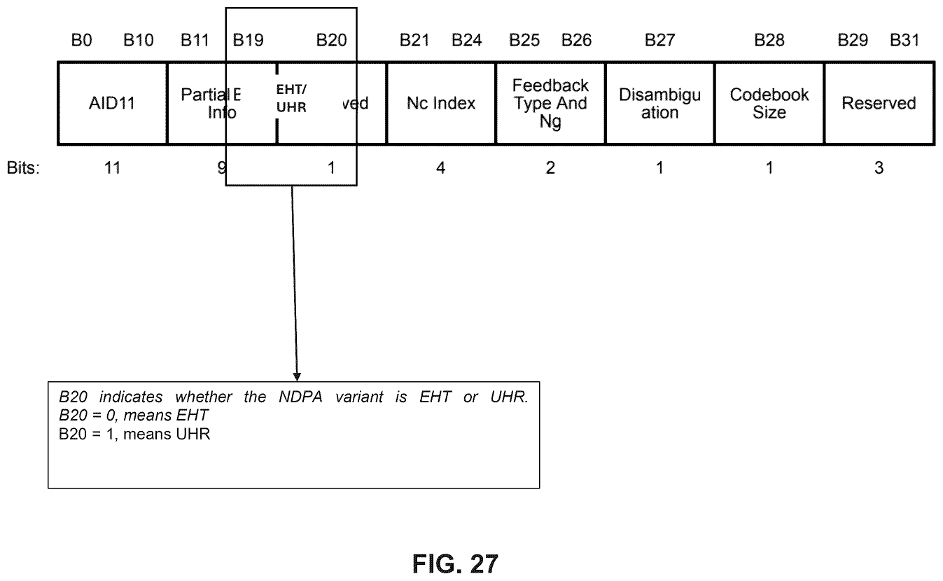

In order to detect the exact NDPA variant type, the reserved B20 is repurposed in the STA Info field to signal for the UHR STAs whether the NDPA variant is EHT or UHR, as shown in FIG. 27.

If the value of B20=0, this indicates an EHT variant. In this case from B21 to B31 includes the same parameters as in the STA Info field format in an EHT NDP Announcement frame. If the value of B20 is set to 1, it indicates to the UHR STA that this is a UHR variant. In this scenario, some or all of the bits from B21 to B31 may either contain the same parameters as the STA Info field in the EHT NDP Announcement frame, following the same or a modified format, or include other additional UHR-specific parameters.

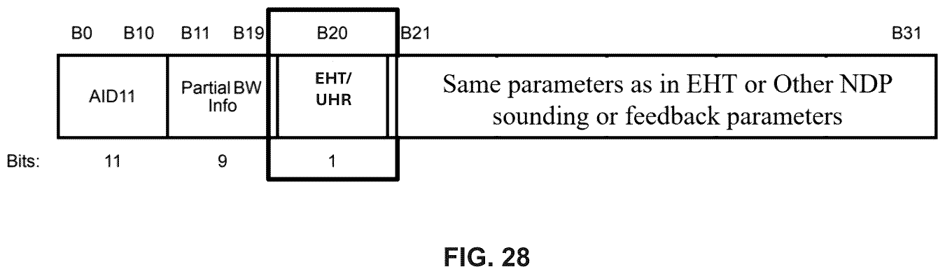

With reference to the sixth embodiment, the UHR STA Info field can be formatted as shown in FIG. 28.

The sixth embodiment can support A-PPDU NDP with EHT/UHR combinations.

A seventh example embodiment is an extension of the sixth embodiment, in which the Co-BF info for the shared AP/BSS STA Info field as well as extending the NDPA frame to accommodate the UHR variant only can be included.

As for the TXOP duration, STAs may infer the TXOP duration from the Duration field in the MAC Header or from the NDP Preamble.

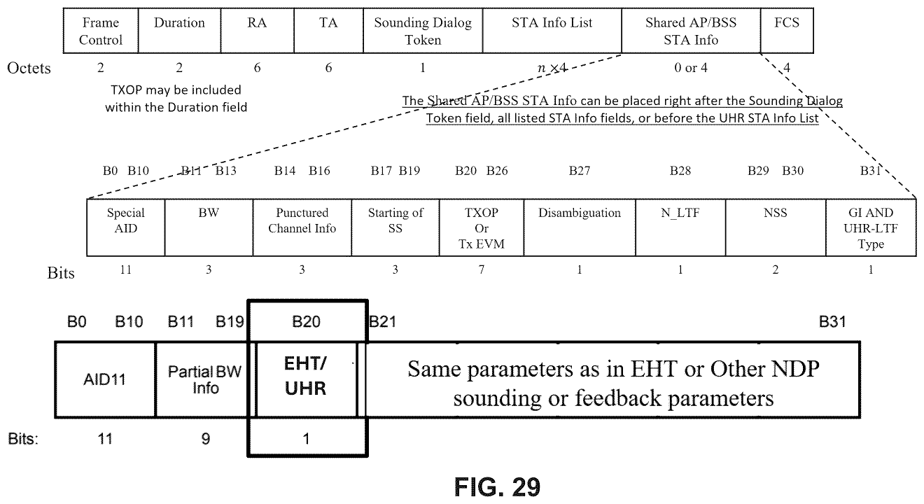

With reference to the seventh embodiment, the proposed format of the NDP Announcement frame, including the Sounding Dialog Token field, is shown in FIG. 29.

The definitions of each subfield within the Shared AP/BSS STA Info field follow that in the first embodiment, except NSS subfield. NSS is represented in 2 bits, where the maximum number of NSS per each UHR AP/non-AP STA is 4.

The Shared AP/BSS STA Info field can be placed right after the Sounding Dialog Token field, after all listed STA Info fields, or before the UHR STA Info List.

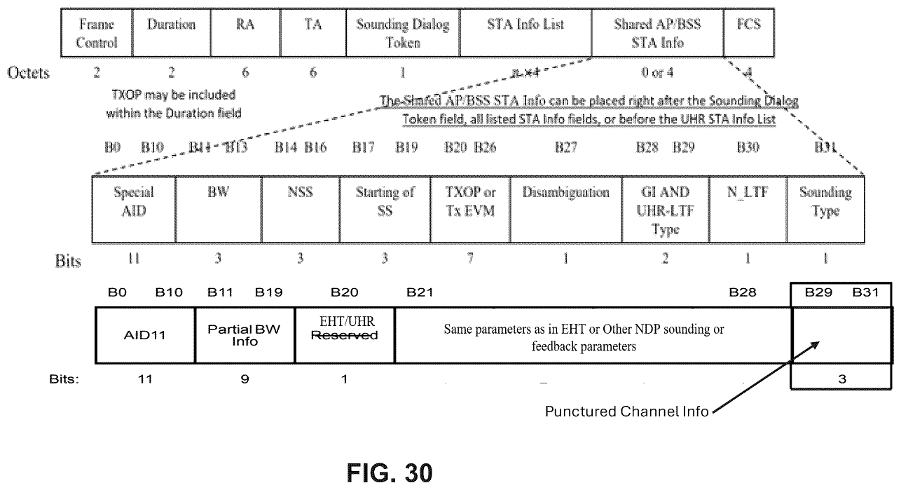

Additionally, some of the Shared AP/BSS STA Info field Info can be included within the UHR STA Info list as shown in the example of FIG. 30.

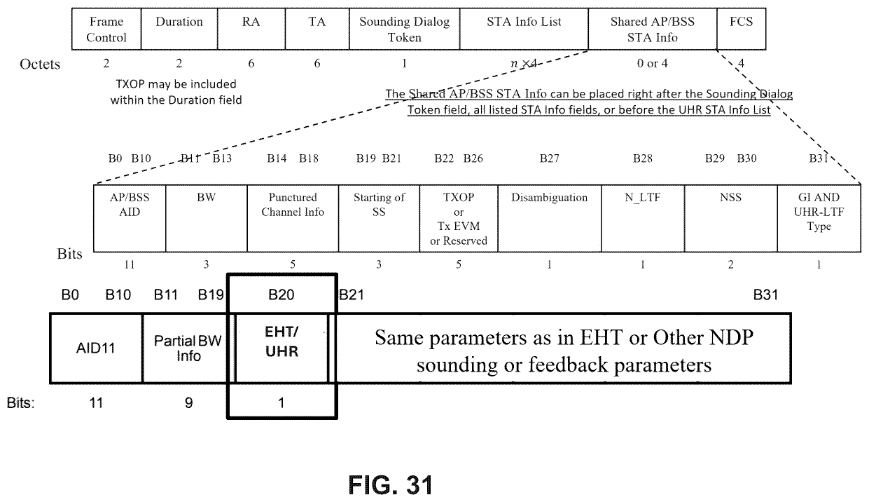

If the Punctured Channel Info field is formatted in 5 bits, then the TXOP or Tx EVM will need to be compressed in 5 bits only or indicate the TXOP in the Duration field and keep these 5 bits as reserved, as a result one of the possible proposed formats of the Shared AP/BSS STA Info field Info field is shown in FIG. 31.

In an eighth example embodiment, a single Sharing AP can perform Co-BF with different APs at different times, but only with one other AP at a time due to the high Co-BF processing complexity.

Utilizing a value of zero in the NDP Announcement Variant subfield to indicate the presence of a Special NDPA Variant STA Info field, which can be used to signal UHR and future variants, may be a suitable option.

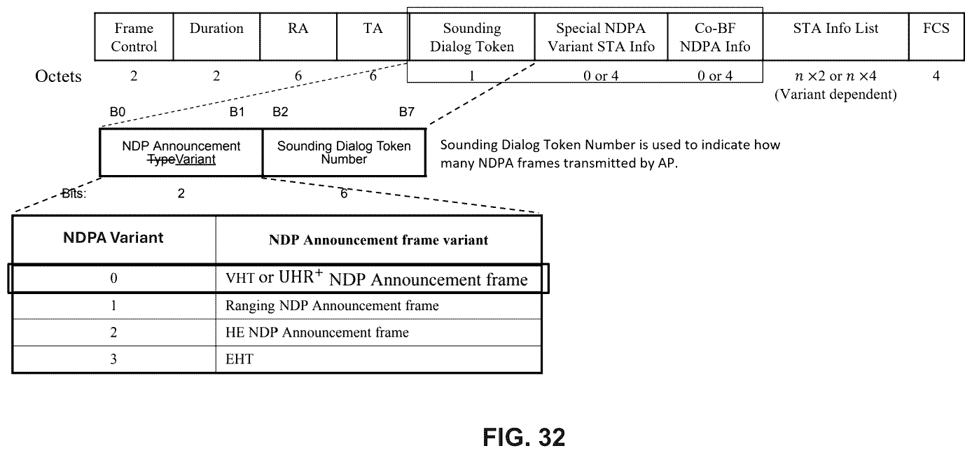

With reference to the eighth embodiment, the proposed format of the NDP Announcement frame, including the Sounding Dialog Token field, is shown in FIG. 32.

If the Sounding Dialog Token with NDP Announcement Variant subfield equals zero is followed by a STA Info field containing an AID between 1 and 2007, then this NDPA frame corresponds to the VHT variant. If the Sounding Dialog Token with NDP Announcement Variant subfield equals zero is followed by a STA Info field containing a Special AID greater than 2007 (a value between 2008 and 2047), then the NDPA frame indicates a UHR or beyond variant.

The specific variant type for NDPA frame is indicated in the Extended NDPA Variant subfield within the Special NDPA Variant STA Info field.

With reference to the eighth embodiment, such Special NDPA Variant STA Info field includes Special AID (12 bits) which value may be greater than 2007 (a value between 2008 and 2047). This value may be a fixed value defined in the standard or assigned value from the Sharing or Coordinating AP to the Shared or Coordinated AP in the OBSS. The Shared or Coordinated AP has to share this Special AID with its associated UHR non-AP STAs. Notably, AID 12 is used for the UHR STA Info fields to align with that in the VHT variant. When the STA decodes the NDPA variant subfield as 0, it will interpret the first 12 bits in the STA Info field as an AID 12, just like in the VHT.

Such Special NDPA Variant STA Info field further includes NDPA Extended Variant Types (3 or 4 bits) to accommodate UHR and beyond variants. Value of 0 is used to indicate UHR NDPA Announcement frame. The remaining values of this subfield are kept reserved for future generations or applications, e.g., sensing, vendor-specific, etc.

such Special NDPA Variant STA Info field includes Extended Co-BF NDPA Info Flag (1 bit) to indicate the presence of the Co-BF NDPA Info field right after the Special NDPA Variant STA Info field; and bit B27 that is the Disambiguation bit and is set to 1 to avoid the wrong detection of AID by VHT devices.

Other remaining bits are kept reserved or may be utilized for other TBD control information. Some of these reserved bits (e.g., B21 to B26) may be utilized as a Co-BF Instance Identifier (Co-BF Instance ID). This Co-BF Instance Identifier may be assigned from the Sharing or Coordinating AP to the Shared or Coordinated AP during the Multi-AP coordination negotiation process as a means of identification within their Co-BF coordination group.

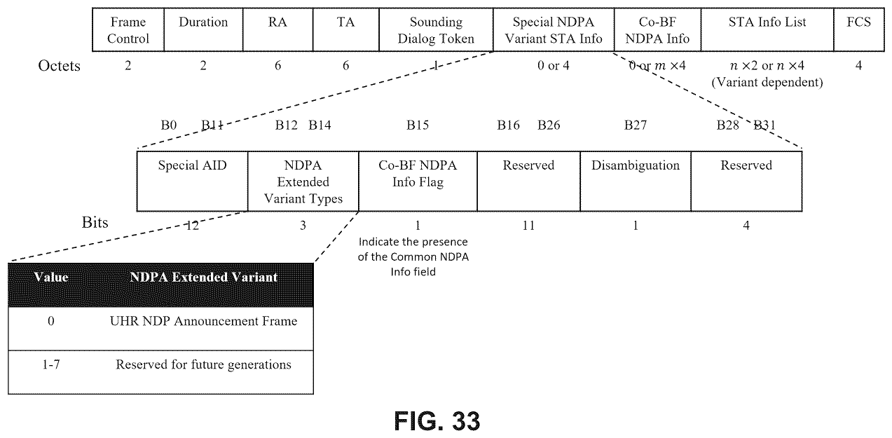

With reference to the eighth embodiment, the proposed format of the Special NDPA Variant STA Info field is as shown in FIG. 33.

If more than two shared APs are allowed to be involved in a Co-BF simultaneously, then one, two, or three of the reserved bits could be used to indicate how many Co-BF NDPA Info fields for different shared APs are included in the NDPA frame.

In order to distinguish between Co-BF NDPA Info for various shared/coordinated APs, the coordinating AP is required to assign a unique AP Identifier to each participating AP during the multi-AP coordination negotiation setup. Given the anticipated limited number of APs involved in Co-BF coordination due to its inherent processing complexity, the coordinating AP may assign a unique AP Identifier, represented by 3, 4, 5, or 6 bits, to each coordinated/shared AP. One viable option for a unique AP Identifier is the BSS Color (6 bits) defined in Clause 26.17.3 of IEEE P802.11-REVme/D5.0, which can be employed to differentiate between Co-BF NDPA Info for distinct shared APs. This frees up more space for incorporating more control information parameters (if needed) to be shared with the Shared AP within “one STA Info field”.

With reference to the eighth embodiment, such example Co-BF NDPA STA Info field includes

Shared AP BSS Color (6 bits) which is included in the UHR Operations Element and announced to all associated STAs and coordinating APs during the multi-AP coordination set-up. This Shared AP BSS Color is used to differentiate between Co-BF NDPA Info for different shared APs, if present.

Such example Co-BF NDPA STA Info field further includes Bandwidth (3 bits) that is set to 0 for 20 MHz; set to 1 for 40 MHz; set to 2 for 80 MHz; set to 3 for 160 MHz; set to 4 for 320 MHz-1; and set to 5 for 320 MHz-2. Values 6 and 7 are Reserved.

Such example Co-BF NDPA STA Info field further includes Punctured Channel Info (5 bits or 3 bits), formatted as in the first embodiment; Starting of Spatial Stream in (3 bits); Number of Spatial Streams (NSS) in (2 or 3 bits); GI AND UHR-LTF Type (2 bits or 1 bits), formatted as in the first embodiment; Number of LTF (N_LTF) (1 bit), formatted as in the first embodiment; Sounding Type (1 bit), formatted as in the first embodiment; TX EVM (7 bits) field that is optional and could be replaced with the Sharing AP's BSS color (6 bits) or other necessary COBF parameters to be shared with the Shared AP; bit B27 that is the Disambiguation bit and is set to 1 to avoid the wrong detection of AID by legacy devices, particularly the VHT devices; bits B11 and B27 that are the Disambiguation bits and are set to 1 to avoid the wrong detection of AID by legacy devices, particularly the VHT devices; and this field also could include other Common Info to be included in the PHY preamble of the NDP frame or the DL Co-BF transmission.

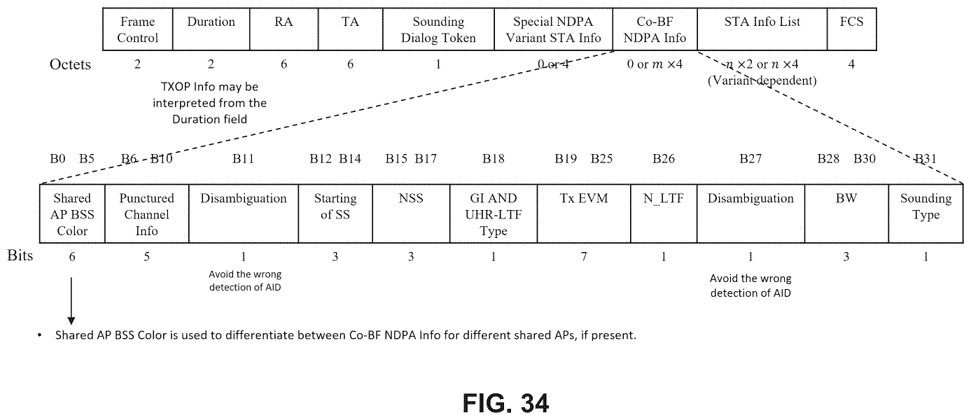

With reference to the eighth embodiment, one of the possible proposed formats of the Co-BF NDPA STA Info field is as shown in FIG. 34.

Notably, the location of each previously defined subfield may be changed/moved in the 4-bytes Co-BF NDPA STA Info/Special NDPA Variant STA Info fields. Some Co-BF Info parameters can be included in the Special Common NDPA STA Info field. This saves more space at the NDPA Info field to accommodate additional control information, if needed.

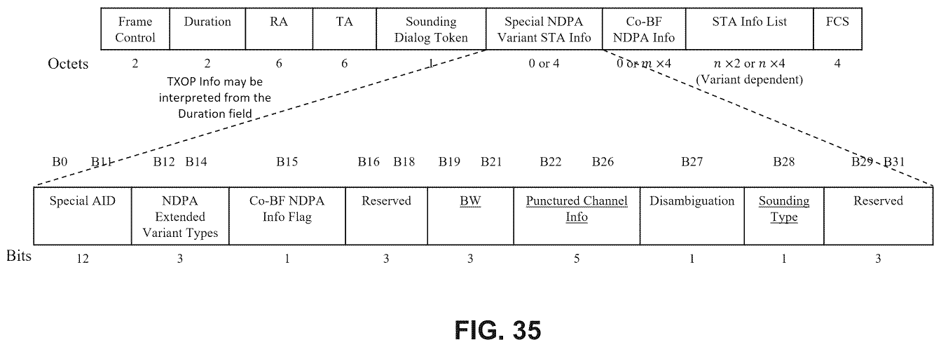

As a result, one way to formulate the Special NDPA Variant Info field is shown in FIG. 35. Some of these reserved bits (e.g., B21 to B26) may be utilized as a Co-BF Instance Identifier (Co-BF Instance ID). This Co-BF Instance Identifier may be assigned from the Sharing or Coordinating AP to the Shared or Coordinated AP during the Multi-AP coordination negotiation process as a means of identification within their Co-BF coordination group.

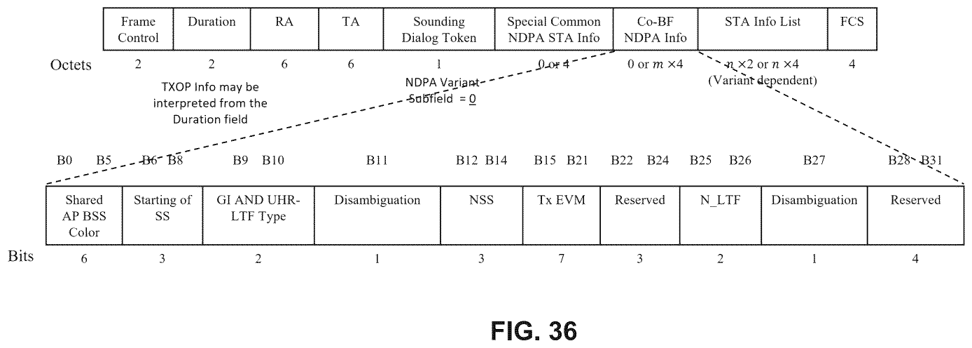

Consequently, with reference to the eighth embodiment, another way to formulate the Co-BF NDPA Info field is shown in FIG. 36.

Notably, the location of each previously defined subfield may be changed/moved in the 4-bytes Co-BF NDPA STA Info/Special NDPA Variant STA Info fields.

Notably, this Shared AP BSS Color Identifier can be replaced with any other unique AP ID represented in 3, 4, 5, or 6 bits. This could save extra bits to be utilized for other TBD control info to be shared with the shared AP for the Co-BF or kept reserved.

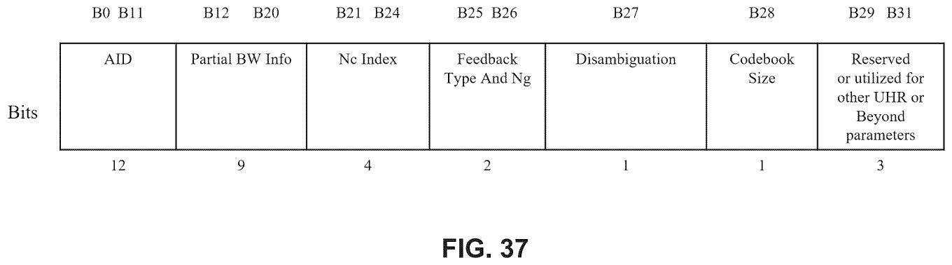

In an example embodiment, the UHR STA Info field is 4 bytes in size and includes the same parameters as those in the EHT NDPA, and it can be formatted as shown in FIG. 37.

Following this, the EHT NDP can still be reused, even for the joint NDP, but in this case the BSS color may be the BSS color of the AP transmitting the NDPA.

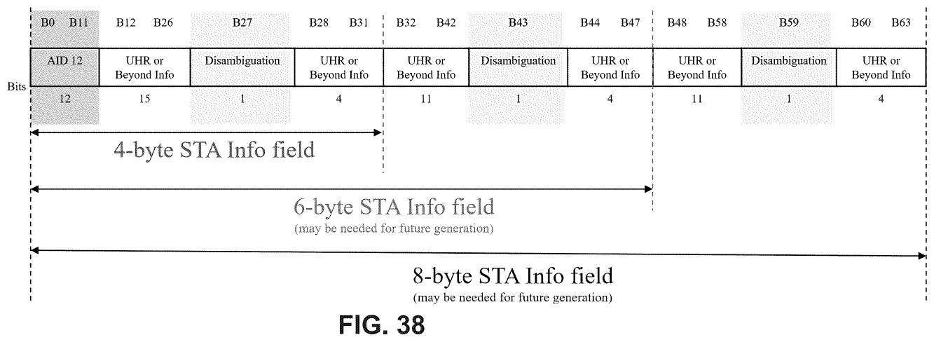

An advantage of accommodating the UHR and future NDPA variants indication alongside the VHT variant is that it allows for easy extension of the STA Info field size to 2×K bytes (with K=2, 3, 4, . . . ) if needed, especially for future beyond UHR generations. This only requires setting each Disambiguation bit (e.g., B27 and B43 for 6-byte STA Info field and B27, B43, and B59 for 8-byte STA Info field) to 1 to avoid wrong AID detection by VHT devices. FIG. 38 is an illustrative example.

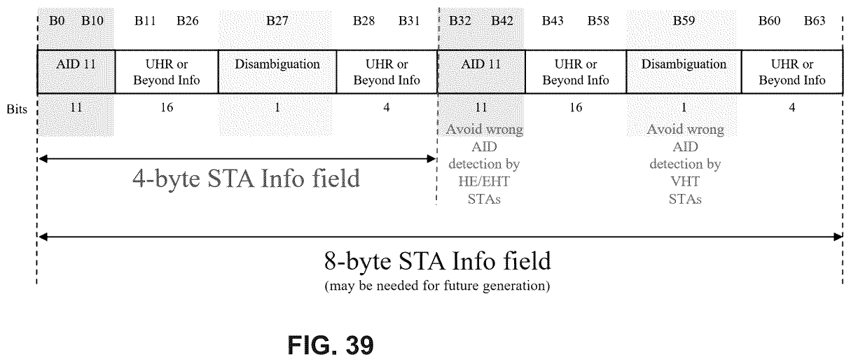

Accommodating the UHR and future NDPA variants indication with HE or EHT variants presents challenges for expanding the STA Info field, if needed to meet future generational needs, as these variants use AID 11. Specifically, STA Info field size could only expand in multiples of 4×K bytes (where K=2, 3, 4, . . . ). Additionally, after every 4 bytes, the first 11 bits must repeat the same AID found in the initial 11 bits of the STA Info field to prevent misinterpretation by legacy HE/EHT STAs, leading to significant bit wastage. For example, expanding the STA Info field to 8 bytes for future needs would result in 13 bits of the 64-bit field being used to avoid AID detection issues, compared to only 3 bits required for disambiguation with VHT STAs in our preferred design. FIG. 39 is an illustrative example.

Another example of the proposed format of the NDP Announcement frame including the Sounding Dialog Token field, as shown in FIG. 4. If4 and discussed previously with reference thereto, is further discussed below with reference to a ninth embodiment.

With reference to the ninth embodiment, if the Sounding Dialog Token with NDP Announcement Variant subfield equal to zero is followed by a STA Info field containing an AID between 1 and 2007, then this NDPA frame corresponds to the VHT variant. If the Sounding Dialog Token with NDP Announcement Variant subfield equaling zero is followed by a STA Info field containing a Special AID greater than 2007 (a value between 2008 and 2047), then the NDPA frame indicates a UHR Co-BF variant.

The UHR Co-BF NDPA Variant includes one 4-byte Special NDPA field which that comes immediately after the Sounding Dialog Token field and before the list of 4-byte STA Info fields.

The Special NDPA Info field includes the NDPA version identifier and other necessary info to be shared with the shared AP to be used for NDP and sounding transmissions.

With reference to the ninth embodiment, such example special NDPA STA Info field includes the following subfields.

If the NDPA is used for COBF transmission, then the first 6 bits includes the Shared AP BSS Color (6 bits). This Shared AP BSS Color is used to differentiate between Co-BF NDPA Info for different shared APs, if present.

If the NDPA is used for non-COBF transmission, then the first 6 bits may be reserved or be set for any other fixed values.

B11 is set to 1 as a disambiguation bit to avoid wrong AID detection by other legacy STAs.

NDPA version Identifier is used to identify the NDPA variant type (e.g., value of 0 for UHR and values 1 to 7 are reserved for beyond UHR variants).

Such example special NDPA STA Info field further includes Bandwidth (3 bits) that is set to 0 for 20 MHz; set to 1 for 40 MHz; set to 2 for 80 MHz; set to 3 for 160 MHz; set to 4 for 320 MHz-1; and set to 5 for 320 MHz-2. Values 6 and 7 are Reserved.

Such example special NDPA STA Info field further includes Punctured Channel Info (5 bits or 3 bits), formatted as in the first embodiment; Starting of Spatial Stream in (1 or 2 bits); Number of Spatial Streams (NSS) in (2 or 1 bits); GI AND UHR-LTF Type (2 bits or 1 bits), formatted as in the first embodiment; Number of LTF (N_LTF) (1 bit), formatted as in the first embodiment; Sounding Type (1 bit) (Optional), formatted as in the first embodiment; BSS color (6 bits) field that is optional and could be replaced with any other necessary COBF parameters to be shared with the Shared AP; bit B27 that is the Disambiguation bit and is set to 1 to avoid the wrong detection of AID by legacy devices, particularly the VHT devices; bits B11 and B27 that are the Disambiguation bits and are set to 1 to avoid the wrong detection of AID by legacy devices, particularly the VHT devices; and this field also could include other Common Info to be included in the PHY preamble of the NDP frame or the DL Co-BF transmission.

For instance, Starting Spatial Stream may be set to 0 or 1 for the 1st or 5th streams, respectively, and Number of spatial streams may be set to 0 or 1 for the 4 or 8 streams, respectively. The LTF+GI may be set to 0 or 1 for 2×LTF+0.8us GI or 2×LTF+1.6us GI, respectively

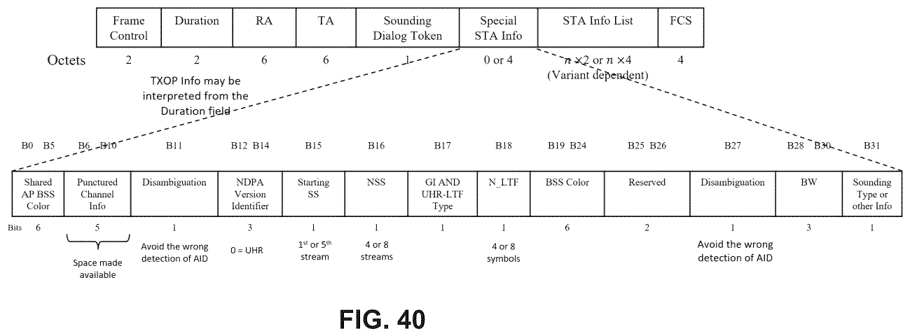

With reference to the ninth embodiment, one of the possible proposed formats of the Co-BF Special NDPA STA Info field is as shown in FIG. 40.

Notably, this Shared AP BSS Color Identifier can be replaced with any other unique AP ID represented in 3, 4, 5, or 6 bits assigned by the Sharing AP. This could save extra bits to be utilized for other TBD control info to be shared with the shared AP for the Co-BF or kept reserved.

For instance, within the Co-BF coordination group, each AP could be assigned a short AP Identifier during the Multi-AP coordination negotiation phase.

Notably, the location of each previously defined subfield may be changed within this 4-bytes Special NDPA STA Info field.

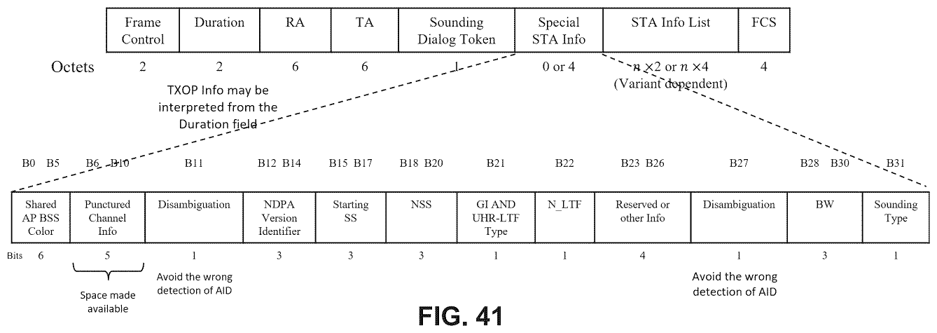

Instead of listing the BSS color field, the value of the sounding type can be relied on to specify the value of BSS color to be included in the PHY preamble of the NDP frame. If the sounding type indicates Joint sounding, this means the value of BSS color to be included in the PHY preamble of the NDP frame is the Sharing AP's BSS color. If the sounding type indicates sequential sounding, this means the value of BSS color to be included in the PHY preamble of the NDP frame is the shared AP's BSS color. As a result, one possible format of the special NDPA STA Info field is shown in FIG. 41.

According to embodiments, extension of the NDPA Frame Format is provided. Such extension may increase available space for new NDPA variants like UHR by optimizing bit allocation, so that important information for future NDPA variants can be included without compromising compatibility with legacy devices.

According to embodiments, introduction of a UHR NDPA Common Info Field is provided. Such introduction may allow efficient sharing of Ultra-High Reliability (UHR) parameters like bandwidth, punctured channel details, and other UHR-related parameters. This supports coordinated beamforming and UHR operations in OBSS networks.

According to embodiments, support for Coordinated Sounding and Beamforming is provided. Such support may enable the exchange of detailed sounding and beamforming parameters between Access Points (APs) in Overlapping Basic Service Sets (OBSSs), improving spatial reuse, communication efficiency, and overall network performance.

According to embodiments, preparation for Future NDPA Variants is provided. Such preparation may, may ensure scalability by reserving fields for future NDPA variants, allowing for seamless integration of upcoming technologies such as UHR+ and Sensing Announcement Frames without requiring major frame revisions.

According to embodiments, common Information Sharing in Coordinated OBSSs is provided, that may facilitate better communication between APs and non-AP STAs by introducing mechanisms for sharing common UHR information, enhancing network coordination and reliability, especially in dense environments.

It will be appreciated that, although specific embodiments of the technology have been described herein for purposes of illustration, various modifications may be made without departing from the scope of the technology. The specification and drawings are, accordingly, to be regarded simply as an illustration of the disclosure as defined by the appended claims, and are contemplated to cover any and all modifications, variations, combinations or equivalents that fall within the scope of the present disclosure. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present disclosure may be implemented by using hardware only or by using software and a necessary universal hardware platform. Based on such understandings, the technical solution of the present disclosure may be embodied in the form of a software product. The software product may be stored in a non-volatile or non-transitory storage medium, which can be a compact disk read-only memory (CD-ROM), USB flash disk, or a removable hard disk. The software product may include a number of instructions that enable a computer device (personal computer, server, or network device) to execute the methods provided in the embodiments of the present disclosure. For example, such an execution may correspond to a simulation of the logical operations as described herein. The software product may additionally or alternatively include number of instructions that enable a computer device to execute operations for configuring or programming a digital logic apparatus in accordance with embodiments of the present disclosure.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via an electronic element depending on the particular context. The term “and/or” herein when used in association with a list of items means any one or more of the items comprising that list.

Although a combination of features is shown in the illustrated embodiments, not all of them need to be combined to realize the benefits of various embodiments of this disclosure. In other words, a system or method designed according to an embodiment of this disclosure will not necessarily include all features shown in any one of the Figures or all portions schematically shown in the Figures. Moreover, selected features of one example embodiment may be combined with selected features of other example embodiments.

Although the present disclosure has been described with reference to specific features and embodiments thereof, it is evident that various modifications and combinations can be made thereto without departing from the disclosure. The specification and drawings are, accordingly, to be regarded simply as an illustration of the disclosure as defined by the appended claims, and are contemplated to cover any and all modifications, variations, combinations or equivalents that fall within the scope of the present disclosure.

1. A method for indicating a Wi-Fi™ standard in a null data physical layer protocol data unit (PPDU) announcement (NDPA) frame, the method comprising:
forming the NDPA frame, wherein:
the NDPA frame includes a sounding dialog token field and a STA info list containing a plurality of entries,
the sounding dialog token field includes a NDPA variant subfield having a value of ‘0’, ‘1’, ‘2’, or ‘3’,
the NDPA variant subfield value of ‘0’ indicates that the NDPA frame includes a Special Common NDPA station (STA) info field and a Coordinated Beamforming (Co-BF) NDPA info field,
the Special Common NDPA STA info field includes a Special Association Identifier (AID) field, an NDPA Extended Variant Type field, an extended Co-BF NDPA info flag, reserved bits and a disambiguation bit,
the extended Co-BF NDPA info field is configured to indicate a presence of a Co-BF NDPA Info field,
when a Punctured Channel info field is three bits in length, the Co-BF NDPA info field includes a three-bit bandwidth (BW) field, the Punctured Channel info field, a two-bit Guard Interval (GI) and Ultra-High Reliability-Long Training Field (UHR-LTF) type field, a three-bit number of spatial streams (NSS) field, a first disambiguation bit, a seven-bit Transmit Opportunity (TXOP) field, a seven-bit Transmission Error Vector Magnitude TXEVM field, a one-bit number of Long Training Fields (LTFs) field, a second disambiguation bit, a three-bit Starting of spatial stream (SS) field, and a one-bit sounding type field,
when the Punctured Channel info field is five bits in length,
the Co-BF NDPA info field includes the three-bit BW field, the Punctured Channel info field, a one-bit GI and UHR-LTF type field, a two-bit NSS field, the first disambiguation bit, the seven-bit TXOP field, the seven-bit TXEVM field, the one-bit number of LTFs, the second disambiguation bit, the three-bit Starting of spatial stream (SS) field, and the one-bit sounding type field,
or
the Co-BF NDPA info field includes the three-bit BW field, the Punctured Channel info field, the three-bit Starting of spatial stream (SS) field, the first disambiguation bit, a three-bit NSS field, a two-bit GI and UHR-LTF type field, the two-bit number of LTFs, the seven-bit TXEVM field, the one-bit sounding type field, the second disambiguation bit, and a four-bit reserved field, the STAs being configured to infer the TXOP duration from the Duration field in a MAC Header or from a Null Data Packet (NDP) Preamble,
the NDPA frame being a Very High Throughput (VHT) NDPA frame when the value of the NDPA variant subfield is equal to ‘0’ and when the sounding dialog token field is followed by an entry of the plurality of entries in the STA info list includes an Association Identifier (AID) that has a value comprised between 1 and 2007,
the NDPA frame being an Ultra-High Reliability (UHR) or beyond NDPA frame when the value of the NDPA variant subfield is equal to ‘0’ and when the sounding dialog token field is followed by an entry of the plurality of entries in the STA info list that includes a Special AID that has a value comprised between 2008 and 2047;
and
transmitting the NDPA frame.

2. A method for indicating a Wi-Fi™ standard in a null data physical layer protocol data unit (PPDU) announcement (NDPA) frame, the method comprising:
forming the NDPA frame, wherein:
the NDPA frame includes a sounding dialog token field and a STA info list containing a plurality of entries,
the sounding dialog token field includes a NDPA variant subfield having a value of ‘0’, ‘1’, ‘2’, or ‘3’,
the NDPA variant subfield value of ‘0’ indicates that the NDPA frame includes a Special NDPA station (STA) info field,
when a Punctured Channel info field is three bits in length, the Special NDPA STA info field includes, in sequence, a Special Association Identifier (AID) field, an NDPA Extended Variant Type field, a bandwidth (BW) field, the punctured channel info field, a starting of spatial stream (SS) field, a number of spatial streams (NSS) field, a disambiguation bit, a Guard Interval (GI) and Ultra-High Reliability-Long Training Field (UHR-LTF) type field, a number of LTFs field, and a sounding type field, or
when the Punctured Channel info field is five bits in length, the Special NDPA STA info field includes, in sequence, the Special AID field, the NDPA Extended Variant Type field, the bandwidth (BW) field, the punctured channel info field, the starting of spatial stream (SS) field, the GI and UHR-LTF type field, the disambiguation bit, the number of spatial streams (NSS) field, the number of LTFs field, and the sounding type field,
the NDPA frame being a Very High Throughput (VHT) NDPA frame when the value of the NDPA variant subfield is equal to ‘0’ and when the sounding dialog token field is followed by an entry of the plurality of entries in the STA info list includes an Association Identifier (AID) that has a value comprised between 1 and 2007,
the NDPA frame being an Ultra-High Reliability (UHR) or beyond NDPA frame when the value of the NDPA variant subfield is equal to ‘0’ and when the sounding dialog token field is followed by an entry of the plurality of entries in the STA info list includes a Special AID that has a value comprised between 2008 and 2047;
and
transmitting the NDPA frame.

3. A method, comprising:
forming a null data physical layer protocol data unit (PPDU) announcement (NDPA) frame that includes a sounding dialog token field and a Special NDPA STA info field, wherein:
the sounding dialog token field includes a NDPA variant subfield having a value of ‘0’, ‘1’, ‘2’, or ‘3’,
the NDPA variant subfield value of ‘2’ or ‘3’ indicates that the NDPA frame includes a Special NDPA station (STA) field that contains a Special Association Identifier (AID),
when the value of the NDPA variant subfield value is ‘2’ or ‘3’ and when the sounding dialog token field is followed by the Special AID has a value comprised between 2008 and 2047, the NDPA frame is an Ultra-High Reliability (UHR) or beyond NDPA frame,
when a Punctured Channel info field is three bits in length, the Special Common NDPA STA info field including, in sequence, the Special AID field, an Extended NDPA Variant field, a bandwidth (BW) field, the Punctured Channel info field, a starting of spatial stream (SS) field, a number of spatial streams (NSS) field, a disambiguation bit, a Guard Interval (GI) and Ultra-High Reliability-Long Training Field (UHR-LTF) type field, a number of LTFs field and a Sounding Type field, or
when the Punctured Channel info field is five bits in length, the Special NDPA STA info field including, in sequence, the Special AID field, the Extended NDPA Variant field, a BW field, the Punctured Channel info field, the SS field, the NSS field, the disambiguation bit, the Sounding Type field, the GI and UHR-LTF type field, and the number of LTFs field;
and
transmitting the NDPA frame.

4. A method for a sharing or coordinating access point (AP) to indicate, to a shared or coordinated AP or a basic service set (BSS), a Wi-Fi™ standard in a null data physical layer protocol data unit announcement (NDPA) frame, the method comprising:
forming the NDPA frame, wherein:
the NDPA frame includes a sounding dialog token field and a STA info list containing a plurality of entries, wherein:
the sounding dialog token field includes a NDPA variant subfield having a value of ‘0’, ‘1’, ‘2’, or ‘3’;
the NDPA variant subfield value of ‘0’ indicates that the NDPA frame includes a Special Common NDPA station (STA) info field that contains a Special Association Identifier (AID),
the NDPA frame is a Very High Throughput (VHT) NDPA frame when the value of the NDPA variant subfield is equal to ‘0’ and when the sounding dialog token field is followed by an entry of the plurality of entries in the STA info list includes an Association Identifier (AID) that has a value comprised between 1 and 2007,
the NDPA frame is an Ultra-High Reliability (UHR) or beyond NDPA frame when the value of the NDPA variant subfield is equal to ‘0’ and when the sounding dialog token field is followed by an entry of the plurality of entries in the STA info list includes a Special AID that has a value comprised between 2008 and 2047,
assigning, to the coordinated AP/BSS, a twelve-bit AP/BSS identifier (ID);
including the twelve-bit AP/BSS ID at a beginning of an entry of the plurality of entries, the entry further comprising a three-bit number of Spatial Streams (NSS), a three-bit starting spatial stream, a two-bit Guard Interval (GI) and Ultra-High Reliability-Long Training Field (UHR-LTF) field, a seven-bit Tx EVM, a disambiguation bit at bit 27 and a one-bit or two-bit number of Long Training Fields (LTFs) field, wherein:
when a Punctured Channel info field is three bits in length:
the Special Common NDPA STA info field includes the Special AID field, the NDPA Extended Variants types field, a bandwidth (BW) field, a Transmit Opportunity (TXOP) field or a reserved field, a disambiguation bit, the Punctured Channel Info field and a Sounding type field,
or
the Special Common NDPA STA info field includes the Special AID field, the NDPA Extended Variants types field, the Punctured Channel Info field, a Transmit Opportunity (TXOP) field or a reserved field, a disambiguation bit, the BW field and a Sounding type field;
and
transmitting the NDPA frame.

5. A method for two or more access points (APs) to indicate, to a basic service set (BSS), a Wi-Fi™ standard in a null data packet null data physical layer protocol data unit announcement (NDPA) frame, the method comprising:
forming the NDPA frame, wherein:
the NDPA frame includes a sounding dialog token field and a STA info list containing a plurality of entries,
the sounding dialog token field includes a NDPA variant subfield having a value of ‘0’, ‘1’, ‘2’, or ‘3’,
the NDPA variant subfield value of ‘2’ or ‘3’ indicates that the NDPA frame includes a Special Common NDPA station (STA) field that contains a Special Association Identifier (AID),
when the NDPA variant subfield value is ‘2’ or ‘3’ and when the sounding dialog token field is followed by an entry of the plurality of entries in the STA info list includes an AID having a value comprised between 1 and 2007, the NDPA frame is a High-Efficiency (HE) NDPA frame or an Extremely High Throughput (EHT) NDPA frame,
when the NDPA variant subfield value is ‘2’ or ‘3’ and when the sounding dialog token field is followed by an entry of the plurality of entries in the STA info list includes an AID or a Special AID having a value comprised between 2008 and 2047, the NDPA frame is an Ultra-High Reliability (UHR) or beyond NDPA frame,
when a Punctured Channel info field is three bits in length, the Special Common NDPA STA info field includes the Special AID field, an NDPA Extended Variants types field, a bandwidth (BW) field, the Punctured Channel info field, a Transmit Opportunity (TXOP) field, a disambiguation bit, a reserved bit and a Sounding Type field,
when the Punctured Channel info field is five bits in length, the Special Common NDPA STA info field includes the Special AID field, the NDPA Extended Variants types field, the Punctured Channel info field, the reserved bit, the TXOP field or reserved field, the disambiguation bit, the BW field and the Sounding Type field,
when a particular AP, the particular AP being one of the two or more APs, signals sounding information to another of the two or more APs or to a Basic Service Set (BSS), the particular AP assign an eleven-bit AP/BSS identifier (ID) to the other of the two or more APs or to the BSS;
including the eleven-bit AP/BSS ID at a beginning of an entry of the plurality of entries of the STA info list, the entry further comprising a starting of Spatial Stream (SS) field, a number of Spatial Streams (NSS) field, a Tx EVM field, a reserved field, a GI AND UHR-LTF, disambiguation bit, a number of Long Training Fields (LTFs) field, and reserved bits;
and
transmitting the NDPA frame.

6. A method for indicating a Wi-Fi™ standard in a null data physical layer protocol data unit (PPDU) announcement (NDPA) frame, the method comprising:
forming the NDPA frame, wherein:
the NDPA frame includes a sounding dialog token field and a STA info list containing a plurality of entries,
the sounding dialog token field including a NDPA variant subfield having a value of ‘0’, ‘1’, ‘2’, or ‘3’, and
when the NDPA variant has the value ‘3’, bit 20 (B20) of an entry of the plurality of entries of the STA info list is repurposed to indicate whether the NDPA frame is an Extremely High Throughput (EHT) NDPA frame or an Ultra-High Reliability (UHR) NDPA frame;
and
transmitting the NDPA frame.

7. A method for indicating a Wi-Fi™ standard in a null data physical layer protocol data unit (PPDU) announcement (NDPA) frame, the method comprising:
forming the NDPA frame, wherein:
the NDPA frame that includes a sounding dialog token field and a station (STA) info list containing a plurality of entries,
the sounding dialog token field includes a NDPA variant subfield having a value of ‘0’, ‘1’, ‘2’ or ‘3’,
when the NDPA variant has the value ‘3’, bit 20 (B20) of an entry of the plurality of entries of the STA info list is repurposed to indicate whether the NDPA frame is an Extremely High Throughput (EHT) NDPA frame or an Ultra-High Reliability (UHR) NDPA frame,
the NDPA frame includes a shared access point (AP)/basic service set (BSS) STA info field,
when a Punctured Channel info field is three bits in length,
the shared AP/BSS STA info field includes a Special Association Identifier (AID) field, a bandwidth (BW) field, the Punctured Channel info field, a starting of Spatial Stream (SS) field, a TXOP or Tx EVM field, a disambiguation bit, a number of Long Training Fields (LTFs) field, a number of SS field and a GI and UHR-LTF type field,
or
the shared AP/BSS STA info field includes the Special AID field, the BW field, the number of SS field, the starting of SS field, the TXOP or Tx EVM field, the disambiguation bit, the GI and UHR-LTF type field, the number of LTFs field and the Sounding Type field, and the entry of the plurality of entries of the STA info list that has the repurposed B20 including the Punctured Channel info field, and
when the Punctured Channel info field is five bits in length, the shared AP/BSS STA info field includes an AP/BSS AID field, the BW field, the Punctured Channel info filed, the starting of SS field, the TXOP or Tx EVM or reserved bits, the disambiguation bit, the number of LTFs field, the number of SS field and the GI and UHR-LTF type field;
transmitting the NDPA frame.

8. A method for indicating a Wi-Fi™ standard in a null data physical layer protocol data unit (PPDU) announcement (NDPA) frame, the method comprising:
forming the NDPA frame, wherein:
the NDPA frame includes a sounding dialog token field, a Special Common NDPA STA info field, a Coordinated Beamforming (Co-BF) NDPA info field, and a STA info list containing a plurality of entries,
the sounding dialog token field includes a NDPA variant subfield having a value of ‘0’, ‘1’, ‘2’, or ‘3’,
when the NDPA variant has the value ‘0’ and when the sounding dialog token field is followed by an entry of the plurality of entries has an Association Identifier (AID) field with a value comprised between 1 and 2007, the NDPA frame is a Very High Throughput (VHT) NDPA frame,
when the NDPA variant has the value ‘0’ and when the sounding dialog token field is followed by the entry of the plurality of entries has an Association Identifier (AID) field has a value comprised between 2008 and 2047, the NDPA frame is an Ultra-High Reliability (UHR) or beyond NDPA frame,
the Special Common NDPA STA info field includes a Special AID field, an NDPA Extended Variant Types field, a Co-BF NDPA info flag, reserved bits, a disambiguation bit and further reserved bits, or
the Special Common NDPA STA info field includes the Special AID field, the NDPA Extended Variant Types field, the Co-BF NDPA info flag, reserved bits, a bandwidth (BW) field, a Punctured Channel info field, a disambiguation bit, a Sounding Type field and additional reserved bits,
the Co-BF NDPA info field includes a shared AP/Basic Service Set (BSS) color, the Punctured Channel info field, a disambiguation bit, a starting of spatial stream (SS) field, a number of SS field, a GI and UHR-LTF type field, a Tx EVM field, a number of Long Training Fields (LTFs) field, a further disambiguation bit, the BW and the Sounding Type, or
the Co-BF NDPA info field includes the shared AP/BSS color, the starting SS field, the GI and UHR-LTF type field, the disambiguation bit, the number of SS field, the Tx EVM field, the number of LTFs field, reserved bits, the further disambiguation bit and further reserved bits;
and
transmitting the NDPA frame.
